(19) United States
(12) Patent Application Publication
(10) Pub. No.: US 2014/0297369 A1
(43) Pub. Date: Oct. 2, 2014

(54) GENERATING A DISCOUNT FOR LACK OF MARKETABILITY

(71) Applicant: Marc Vianello, Overland Park, KS (US)

(72) Inventor: Marc Vianello, Overland Park, KS (US)

(21) Appl. No.: 14/222,983

(22) Filed: Mar. 24, 2014

Related U.S. Application Data
(63) Continuation-in-part of application No. 13/853,753, filed on Mar. 29, 2013.

(51) Int. Cl. G06Q 30/02

(52) U.S. Cl. CPC G06Q 30/0206
USPC 705/7.35

(57) ABSTRACT

A method, system, and medium for generating a double-probability-weighted discount for lack of marketability (DLOM) for an asset to be valued. Selections of parameters associated with the asset to be valued and of representative assets for which price data is available are received. A mean and standard deviation of marketing periods associated with the selected parameters and of price volatilities depicted by the price data are calculated. A statistical modeling application generates probability distributions based on the means and standard deviations of the marketing periods and of the price volatilities. DLOMs are calculated for each combination of marketing period and price volatility. The DLOMs are weighted based on the probabilities depicted by the probability distributions and summed to provide the double-probability-weighted DLOM, which is presented to the user via a user interface.

### CROSS-REFERENCE TO RELATED APPLICATIONS

This application is a continuation-in-part and claims the benefit of U.S. patent application Ser. No. 13/853,753, filed Mar. 29, 2013, the disclosure of which is hereby incorporated herein, in its entirety, by reference.

### BACKGROUND

The business valuation concept of marketability deals with the liquidity of the ownership interest. How quickly and certainly an owner can convert an investment to cash represent two very different variables. The “quickly” variable represents the period of time it will take the seller to liquidate an investment. This period of time can vary greatly depending on the standard of value in play. For example, liquidation sales can occur quickly and generally reflect lower prices, while orderly sales usually take longer to explore the marketplace of reasonable buyers and generally reflect greater than liquidation prices. In every instance, however, the “quickly” variable commences with a decision by the seller to initiate the sales process. The “certainty” variable represents the probability that the seller will realize the estimated sale price (value) of the investment. Therefore, the “certainty” variable represents the price volatility of the investment during the period of time that it is being offered for sale. If market prices for similar investments fall dramatically while the marketplace is being explored, then the seller will have lost the opportunity to lock in the higher price that existed at the time the sell decision was made. Conversely, if the sale price is fixed for some reason (e.g., a listing agreement) and market prices for similar investments rise dramatically during the marketing period, the seller will have lost the opportunity to realize the increased value.

The “quickly” and “certainty” variables work together when determining the value of an investment. Relative to immediately marketable investments, the value of illiquid investments (regardless of the level of value) must be discounted to reflect the uncertainty of the time and price of sale. This uncertainty is reflected in business valuations by what is commonly known as the “discount for lack of marketability” (DLOM).

Logically, the economic costs of time and price uncertainty can be reduced to the price risk faced by an investor during the particular period of time that an illiquid investment is being offered for sale. In the market for publicly traded stocks, the volatility of stock prices represents risk. Investments with no price volatility have no DLOM, because they can be arbitraged to negate the risk of a period of restricted marketing. Conversely, volatile investments that are immediately marketable can be sold at the current price to avoid the risk of future volatility. The illiquidity experienced by the seller of a non-public business interest during the marketing period therefore represents an economic cost reflective of the risk associated with the inability to realize gains and to avoid losses during the period of illiquidity. The longer that time period, the more the value of the business is exposed to adverse events in the marketplace and adverse changes in the operations of the business, and the greater the DLOM that is required to equate the investment to an immediately liquid counterpart.

Conventional business valuation has used the well-publicized results of restricted stock studies, pre-IPO studies, and registered versus unregistered stock studies to effectively guess at appropriate DLOM percentages to use in their valuation reports. Understandably, such subjective means of applying the traditional approaches have been broadly unsatisfactory to the valuation community and the courts.

A variety of data sources or types have been employed by researchers to perform empirical studies to explore the cost of illiquidity. Some of the most widely used data sources are described below.
A. Publicly traded companies are the standard against which all of the studies measure results and from which rates of return are calculated. Interests in publicly traded companies are worth more than interests in identical privately held companies because they can be sold immediately to realize gains and to avoid losses. Interests in privately held companies cannot.
B. Private sales of publicly registered stocks typically involve large blocks of stock that could be sold into the public marketplace, but which would materially adversely affect stock prices if the entire block were to be dumped into the market at once. Avoiding that effect results in an extended period of time to liquidate the investment position in the public market during which time the investor is subject to market risk. Negotiating a private sale of the block can accelerate liquidating the position, but the need to find a buyer with the wherewithal to purchase the block restricts the number of potential buyers and represents a diminution of demand for the stock. Furthermore, although private sales of large blocks of registered stocks can somewhat mitigate the market risk, the risk does not go away. The buyer of the block assumes the risks, in turn, of having to sell into a limited pool of buyers or slowly feeding the block into the public market. These risks require compensation by means of a discount (i.e. DLOM).
C. Private sales of restricted stocks in public companies have the same price risks as private sales of large blocks of registered stocks, but have the additional risk of being locked out of the public market for specific periods of time or being subject to restrictive “dribble out” rules. Accordingly, restricted stocks often can only be sold quickly in private sale transactions, which take longer than it does to sell unrestricted stocks in the public market. Some restricted stocks cannot be sold at all for contractually determined periods of time. Such investments have even greater economic risks than those merely subject to the “dribble out” rules. The result is that a restricted registered stock is worth less than an unrestricted stock in the same company because of the greater market risk associated with the extended marketing period.
D. Private sales of unregistered stocks in public companies typically involve large blocks of stock. They are worth less than equivalent blocks of registered stock (whether restricted or unrestricted) in the same publicly traded company because there is a cost to ultimate registration of the stock that further restricts the potential number of buyers of the block. This results in relatively greater uncertainty, a relatively longer time to market the interest, and a relatively greater exposure to the risks of the marketplace.
E. Pre-IPO private sales of controlling interests should have relatively longer marketing periods than for private sales of unregistered stocks in public companies, because the fact and timing of the IPO event can be uncertain. Furthermore, low pre-IPO stock sales prices may reflect compensation for services rendered. There are no publically known studies that specifically address discounts observed in sales of controlling interests in pre-IPO companies.
F. Private sales of controlling interests in a company that has no expectation of going public should be worth less than an otherwise identical company with an anticipated IPO event. Uncertain or not, an anticipated IPO event should result in a shorter marketing period than not anticipating such an event.
G. Pre-IPO sales of non-controlling interests in a company planning an IPO event should be worth less than the controlling interest in the same company even without the planned IPO. The inability to control whether the planned IPO goes forward should result in greater uncertainty and a longer marketing period to liquidate the investment than would be experienced by the controlling investor. Also, low pre-IPO share prices may reflect compensation for services rendered.
H. Non-controlling interests in private companies require greater discounts than all of the preceding circumstances because the relative risks of lacking control cause the period of time to liquidate the position to be potentially much longer than for the controlling interest in the same company or for otherwise comparable minority positions in firms with a planned IPO event.

Restricted stock studies and pre-initial public offering (“pre-IPO”) studies have been used to quantify DLOM since the early 1970s. Despite making a good case for the need for a DLOM when valuing an investment that is not immediately marketable, the study results are unreliable for calculating the DLOM applicable to a particular valuation engagement.

Unfortunately, the empirical studies of marketability discounts have limited utility to the appraiser opining on the fair market value of a business interest. Several authors have noted that most publicly traded firms do not issue restricted stock. This dearth necessitates samples of limited sizes, in limited industries, with data spread over long periods of time. The result has been substantial standard errors in their estimates.

The restricted stock studies measure the difference in value between a publicly traded stock with and without a time restriction on sale. Left unanswered is whether there is a difference between the restricted stock value of a publicly traded company and the value of that company if it were not publicly traded at all.

The pre-IPO studies reflect substantial standard errors in their estimates for similar reasons, but are also distorted by the facts that the studies necessarily are limited to successful IPOs; there are no post-IPO stock prices for failed IPOs. The discounts observed in the pre-IPO studies may also reflect uncertainty about whether the IPO event will actually occur, when the IPO event will occur, at what price the event will occur, and compensation for services rendered.

It should also be noted that the companies in the restricted stock and pre-IPO studies are, in fact, publicly traded. But essentially none of the privately held companies that are the subject of business valuations have a foreseeable expectation of going public. Accordingly, the circumstances of the privately held companies are highly distinguishable from those of the publicly traded companies that are the subjects of the studies. Thus, the pre-IPO studies are of dubious value for determining the DLOM of privately held companies.

There is at least one known study of the difference in value between private sales of registered stocks and private sales of unregistered stocks in the same publicly traded company. The result is a measure of the value of registration; it is not a measure of liquidity, much less a measure of DLOM. It is not appropriate to estimate DLOM and fair market value (FMV) relying exclusively on lack of registration, which is a factor subsumed in the time it takes to market an interest in a private company. Likewise, brokerage and transactions costs should not be deducted from fair market value appraisals. The result of such deductions would be values that no longer represent the price at which the investments change hands between buyers and sellers—a requirement of fair market value.

Restricted Stock Studies

Restricted stocks are public company stocks subject to limited public trading pursuant to SEC Rule 144. Restricted stock studies attempt to quantify DLOM by comparing the sale price of publicly traded shares to the sale price of otherwise identical marketability-restricted shares of the same company. The average (“mean”) marketability discount and related standard deviation (where available) determined by each of the published restricted stock studies is provided in FIG. 1.

In 1997, the SEC reduced the two-year restriction period of Rule 144 to one year. Subsequently, Columbia Financial Advisors, Inc. completed a study that analyzed restricted stock sales from May 1997 through December 1998. This study found a range of discounts from 0% to 30%, and a mean discount of 13%. The conclusion reached from this study is that shorter restriction periods result in lower discounts. In 2008, the SEC further reduced the Rule 144 restriction period to six months. According to the Internal Revenue Service, as of the present date no restricted stock studies have been published that reflect the six-month holding period requirement. Considering the age of the restricted stock studies, the Rule 144 transitions, and changes in market conditions, concluding that a DLOM derived from the above studies ignores current market data and conditions seems unavoidable.

Appraisers face other serious problems when relying on these studies. Because the sample sizes of the restricted stock studies are small, most involving less than 100 individual data points, the reliability of the summary statistics is subject to considerable data variation. This fact alone calls the reliability of the studies into question. But the studies also report high standard deviations, as shown in the FIG. 1, indicating the probability of a very broad range of underlying data points. Relying solely on the averages of these studies is, therefore, likely to lead the appraiser to an erroneous DLOM conclusion.

A graphical model of a 200,000-trial normal statistical distribution based on the reported means and standard deviations of the 146-observation Moroney study was generated using a predictive modeling, forecasting, simulation, or optimization application, such as Crystal Ball from the Oracle Corporation of Redwood City, Calif. Crystal Ball is a widely accepted modeling software program that uses a Monte Carlo simulation to randomly generate values for uncertain variables based on defined assumptions. The model discloses that the potential range of discounts comprising the 35% mean discount of the Moroney study is from negative 44.5% to positive 113.9%. Applying the same normal distribution analysis to the Maher, Silber, and Management Planning studies discloses that the potential range of discounts comprising the Maher study average of 35.0% is from negative 41.0% to positive 110.6%; the potential range of discounts comprising the Silber study average of 34.0% is from negative 75.8% to positive 138.0%; the potential range of discounts comprising the 49-observation Management Planning study is from negative 32.5% to positive 83.1%; and the potential range of discounts comprising the 20-observation Management Planning study is from negative 29.9% to positive 83.7%.

Common sense tells one that a DLOM cannot be negative. Therefore, normal statistical distribution likely cannot be the appropriate assumption regarding the distribution of the population of restricted stocks. A log-normal distribution may instead be assumed for the population. Using Crystal Ball or similar application with the log-normal assumption and 200,000 trials resulted in a graphical model that discloses that the log-normal range of discounts comprising the Moroney study is from 3.7% to 269.2% with a median discount of 31.1%. Approximately 60% of probable outcomes occur below the study mean.

Applying the same log-normal distribution analysis to the Maher, Silber, and Management Planning studies, we find: the log-normal range of discounts comprising the Maher study is from 4.0% to 276.6% with a median discount of 31.2%; the log-normal range of discounts comprising the Silber study is from 2.0% to 472.8% with a median discount of 27.8%; the log-normal range of discounts comprising the Management Planning study is from 2.7% to 233.1% with a median discount of 25.0%. In each of these studies, approximately 60% or more of probable outcomes occur below the study mean.

Even assuming a log-normal distribution the appraiser is left with two problems. First, what should be done about the fact that some portion of the distribution continues to imply a DLOM greater than 100%? That result should not simply be ignored. Some form of adjustment may be required. Second, with 60% or more of the predicted outcomes occurring below the reported means of the studies, there is no basis for assuming a DLOM based on a study's mean (or an average of studies' means). These issues, the inability of the studies to reflect market dynamics (past or present), the inability to associate the studies with a specific valuation date, and the inability to associate the study results to a valuation subject with any specificity, seriously call into question the reliability of basing DLOM conclusions on restricted stock studies. Pre-IPO Studies

Pre-IPO studies analyze otherwise identical stocks of a company by comparing prices before and as-of the IPO date. As with the restricted stock studies, the valuation utility of the pre-IPO studies is seriously flawed. For example, the “before” dates of these studies use different measurement points ranging from several days to several months prior to the IPO. Determining a “before” date that avoids market bias and changes in the IPO company can be a difficult task. If the “before” date is too close to the IPO date, the price might be affected by the prospects of the company's IPO. If the “before” date is too far from the IPO date, overall market conditions or company specific conditions might have changed significantly. Such circumstances undermine the use of pre-IPO studies to estimate a specific DLOM.

The Internal Revenue Service document, Discount for Lack of Marketability Job Aid for IRS Valuation Professionals, published Sep. 25, 2009, the disclosure of which is hereby incorporated herein by reference, discusses three pre-IPO studies: the Willamette Management Associates studies; the Robert W. Baird & Company studies; and the Valuation Advisors' Lack of Marketability Discount Study. Each of these studies suffers from deficiencies that undermine their usefulness for estimating the DLOM applicable to a specific business as of a specific date. First, the Willamette and Baird & Company studies were of limited size and are not ongoing. The Willamette studies covered 1,007 transactions over the years 1975 through 1997 (an average of 44 transactions per year), while the Baird & Company studies covered 346 transactions over various time periods from 1981 through 2000 (an average of 17 transactions per year). While the Valuation Advisors studies are ongoing and larger than the others, covering at least 9,075 transactions over the years 1985 to present, it represents an average of just 336 pre-IPO transactions per year. Although larger than the restricted stock studies discussed in the previous section, the sample sizes of these pre-IPO studies remain small on an annual basis and subject to considerable data variation. This fact alone calls the reliability of the pre-IPO studies into question.

Second, the Willamette and Baird & Company studies report a broad range of averages, and very high standard deviations relative to their means (reflecting the broad range of underlying data points). The “original” Willamette studies report standard mean discounts that average 39.1% and standard deviations that average 43.2%. The “subsequent” Willamette studies report standard mean discounts that average 46.7% and standard deviations that average 44.8%. And the Baird & Company studies report standard mean discounts that average 46% and standard deviations that average 45%.

Using Crystal Ball or a similar application to model a 200,000-trial normal statistical distribution based on the reported means and standard deviations of the “original” Willamette studies discloses that a potential range of discounts comprising the 39.1% mean discount of this study ranges from negative 167.6% to positive 235.8%.

Applying the same normal distribution analysis to the “subsequent” Willamette studies and the Baird & Company studies discloses that the potential range of discounts comprising the “subsequent” Willamette studies is from negative 151.2% to positive 239.9%. And the normal distribution of a 206-observation subset of the aforementioned Baird & Company studies with a reported mean discount of 44% and standard deviation of 21% discloses that the potential range of discounts ranges from negative 59.8% to positive 150.6%.

As with the restricted stock studies, common sense tells one that a DLOM cannot be negative. Therefore, normal statistical distribution likely cannot be the appropriate assumption regarding the distribution of discounts within the populations, and a log-normal distribution may be assumed instead. Using Crystal Ball or a similar application, the log-normal assumption, and 200,000 trials results in a graphical model that discloses that the log-normal range of discounts comprising the “original” Willamette study ranges from 0.5% to 1,151.2% with a median discount of 26.3%. Almost 70% of probable outcomes occur below the 39.1% mean discount of the study.

On a log-normal basis, the potential range of discounts comprising the “subsequent” Willamette studies is from 1.3% to 1,192.9% with a median discount of 33.8%. Over 60% of probable outcomes occur below the mean discount of the study. And on a log-normal basis the potential range of discounts comprising the Baird & Company studies is from 5.7% to 327.3% with a median discount of 42.7%. Approximately 60% of probable outcomes occur below the mean discount of the study.

These statistical problems of the pre-IPO studies and the inability to (a) align with past and present market dynamics; (b) a specific valuation date; and (c) a specific valuation subject, seriously call into question the reliability of basing DLOM conclusions on pre-IPO studies.

Third, the volume of IPO transactions underlying the pre-IPO studies is shallow and erratic. During one five-year period the peak volume of offerings was 26 in November 2010 and in January 2009 there were no IPOs at all. From September 2008 through March 2009 the average number of IPOs priced was less than 1.3 per month. It is difficult to understand a rationale for estimating DLOM for a specific privately held company at a specific point in time based on such limited data.

Fourth, the Tax Court has found DLOM based on the pre-IPO approach to be unreliable. In McCord v. Commissioner, 120 T.C. 358 (2003), the court concluded that the pre-IPO studies may reflect more than just the availability of a ready market. Other criticisms were that the Baird & Company study is biased because it does not sufficiently take into account the highest sales prices in pre-IPO transactions and the Willamette studies provide insufficient disclosure to be useful.

Problems with Existing Analytical Methods to Measure DLOM

It has been suggested that the Black-Sholes Option Pricing Model (“BSOPM”) represents a solution to the DLOM conundrum. It does not. BSOPM is not equivalent to DLOM on a theoretical basis. BSOPM is designed to measure European put and call options. European put options represent the right, but not the obligation, to sell stock for a specified price at a specified point in time. European call options represent the right, but not the obligation, to buy stock for a specified price at a specified point in time. DLOM is not the equivalent of either. Instead, DLOM represents the risk of being unable to sell at the marketable equivalent price for a specified period of time.

“At the money” put options have also been suggested as a means of estimating DLOM. Such options represent the right, but not the obligation, to sell stock at the current price at a specified future point in time. Such options do not measure the risk of illiquidity, because the investor is not denied the opportunity to sell for a price that is higher than the put price.

The Longstaff Approach for Computing DLOM

The critical value difference between publicly traded and privately held companies is that publicly traded investments offer liquidity. All other components of business value are shared: earnings and cash flow, growth, industry risk, size risk, and market risk. However, it is not the value of liquidity per se that DLOM seeks to capture. Instead, it is the risk associated with illiquidity.

Liquidity is the ability to sell quickly when the investor decides to sell. Liquidity allows investors to sell investments quickly to lock in gains or to avoid losses. DLOM, being the result of illiquidity, represents the economic risk associated with failing to realize gains or failing to avoid losses on an investment during the period the investor is trying to sell it. This is not necessarily a zero sum game. The value of liquidity (measured, for example, as the spread between registered and unregistered stocks of the same publicly traded company) does not translate into the economic risks faced by investors in private companies. This is because such measures of liquidity do not account for the even longer marketing periods likely to be incurred by investors in private companies compared to investors in unregistered stocks of otherwise publicly traded companies.

Logically, DLOM can be reduced to price risk faced by an investor during a particular marketing period. In the market for publicly traded stocks, risk reflects the volatility of stock prices. Conversely, investments with no price volatility or that are immediately marketable have no DLOM. Investments with no price volatility can be arbitraged to negate the period of restricted marketing, while volatile investments that are immediately marketable can be sold at the current price to avoid future volatility.

In 1995, UCLA professor Francis A. Longstaff published an article in The Journal of Finance, Volume I, No. 5, December 1995, the disclosure of which is hereby incorporated herein by reference, that presented a simple analytical upper bound on the value of marketability using “look back” option pricing theory. Longstaff's analysis demonstrated that discounts for lack of marketability (“DLOM”) can be large even when the illiquidity period is very short. Importantly, the results of Longstaff's formula provide insight into the relationship of DLOM and the length of time of a marketability restriction. Longstaff described the “intuition” behind the results of his formula as follows—
[Consider] a hypothetical investor with perfect market timing ability who is restricted from selling a security for T periods. If the marketability restriction were to be relaxed, the investor could then sell when the price of the security reached its maximum. Thus, if the marketability restriction were relaxed, the incremental cash flow to the investor would essentially be the same as if he swapped the time-T value of the security for the maximum price attained by the security. The present value of this lookback or liquidity swap represents the value of marketability for this hypothetical investor, and provides an upper bound for any actual investor with imperfect market timing ability.

FIG. 2 is a graphical presentation of Longstaff's description, in which an investor receives a share of stock worth $100 at time zero, but which he cannot sell for T=2 years when the stock is worth $154 (present value at T=0 discounted at a risk free rate of 5%=$139). If at its peak value the stock were worth $194 (present value at T=0 discounted at a risk free rate of 5%=$180), then the present value cost of the restriction to the investor at T=0 would be $41, or 41% of his $100 investment.

The mathematical formula of this scenario is—

$$Discount = V ( 2 + \frac{{σ}^{2} T}{2} ) N ( \frac{\sqrt{{σ}^{2} T}}{2} ) + V \sqrt{\frac{{σ}^{2} T}{2 π}} exp ( - \frac{{σ}^{2} T}{8} ) - V$$

where:
V=current value of the investment
σ=volatility
T=marketability restriction period
N=standard normal cumulative distribution function
exp(x)=Euler's constant (e=2.71828182845904) raised to the x power

Criticisms of what is now known as the Longstaff methodology have focused on three perceived defects: (1) no investor has perfect knowledge; (2) a DLOM based on an upper bound is excessive; and (3) the look back option formula “breaks down” with long marketing periods and high price volatilities. Each of these criticisms is wrong for the reasons described below.

### The “Perfect Knowledge” Criticism

The “perfect knowledge” criticism is based on a defective definition of market timing in a valuation context. The context considered by Dr. Longstaff was one of an investor looking back in time to observe precisely when an investment could have been sold at its maximum value. Dr. Longstaff implicitly assumed that the maximum price could have been reached at any point during the look back period. But in a valuation context this seemingly reasonable assumption is not appropriate. Instead, the maximum price occurs on the valuation date and is the marketable value of the valuation subject. Appraisers determine this value in the ordinary course of their work.

Standing on the vantage point of the valuation date and applying look back option pricing to calculate DLOM in a business valuation inherently assumes that the maximum price that the investor could have realized for the investment is the marketable equivalent price as of that date. The value of the investment beyond the valuation date is necessarily less. This is because the time value of money diminishes the present value of the marketable equivalent price over the course of the marketing period; the foreseeable favorable events affecting the valuation subject have been factored into the analysis; and investors are averse to the risks of price volatility. Thus, if the appraiser properly determined the marketable equivalent price as of the valuation date, then that price is the “maximum value” postulated by Dr. Longstaff.

### The “Upper Bound” Criticism

Dr. Longstaff described the framework in which an upper bound on the value of marketability is derived as one lacking the assumptions about informational asymmetries, investor preferences, and other variables that would be required for a general equilibrium model. Dr. Longstaff recognized that the cost of illiquidity is less for an investor with imperfect market timing than it is for an investor possessing perfect market timing. These considerations are the basis of the “upper bound” limitation of the Longstaff methodology.

It is understood that the cost of illiquidity should be less for the average investor with imperfect market timing than it is for an investor possessing perfect market timing. But the “upper bound” criticism resulting from this situation is nonetheless defective in the valuation context because it can be circumvented by using volatility estimates that represent average, not peak, volatility expectations. For example, the appraiser's volatility estimate may be based on some average or regression of historical price volatility derived from an index, one or more publicly traded companies, or another asset, guideline, or benchmark. In one embodiment, one or more guidelines that have characteristics in common with the asset to be valued are identified. An annualized average stock price volatility for each of the guidelines may be calculated, for example, based on a historical period of time equal to the period of time that it is believed it will take to market the asset being valued. Other means of estimation may be used. The calculated volatilities can be averaged using a simple, weighted, harmonic, or other averaging methodology, or can be considered individually.

Using average volatility estimates in the look back option formula results in a value that is less than the “upper bound” value. Indeed, a value calculated using average expected volatility suggests a result that is achievable by the average imperfect investor. The resulting value determined in this manner appropriately falls short of a value based on perfect market timing while providing for the informational asymmetry lacking in Dr. Longstaff's more simplified framework.

Accordingly, the “upper bound” criticism has no significance in a proper application of the Longstaff methodology.

### The “Formula Breaks Down” Criticism

The IRS publication “Discount for Lack of Marketability—Job Aid for IRS Valuation Professionals” makes the statement that volatilities in excess of 30% are not “realistic” for estimating DLOM using look back option pricing models. In support of this contention, the publication provides a table reporting marketability discounts in excess of 100% resulting from using combinations of variables of at least 50% volatility with a 5-year marketing period and 70% volatility with a 2-year marketing period. When that occurs, the Longstaff DLOM should simply be capped at 100%. After all, the criticism is not that the formula incorrectly calculates DLOMs below the 100% limit; merely that DLOM cannot exceed 100%.

For example, Longstaff DLOMs for an exemplary asset calculated based on a 20% price volatility assumption and a broad range of marketing periods indicate that it takes about 6,970 days—over 19 years—for the discount to reach 100%. Considering that the average privately held business sells in about 200 days, a criticism based on a 19-year marketing period is clearly unreasonable. As the expected price volatility increases, a shorter time is typically required to reach 100% and vice-versa. Considering the average period of time in which a private business sells, it is unlikely that typical appraisers will define look back option variables that result in Longstaff DLOMs that exceed 100%.

Some appraisers may nonetheless struggle with the idea of using a formula to calculate DLOM that “breaks down” under certain assumptions. The dilemma is avoided by applying the formula Adjusted DLOM=Average DLOM/(1+Average DLOM). This adjustment assures that even with the highest volatilities and longest marketing periods DLOM never exceeds 100%. For example, the IRS publication reports a discount percentage of 106.7% based on an estimated 70% price volatility over an estimated 2-year post valuation date marketing period. The DLOM percentage resulting from the same parameters and using the above technique is 51.6%. This modification of the Longstaff method makes it mathematically impossible for the resulting percentage to equal or exceed 100% of the marketable value of the valuation subject. But adjusted DLOM increasingly understates Longstaff DLOM as the marketing period assumption lengthens and as the price volatility assumption elevates.

Because the variables entering into the generally accepted look back option formula can be objectively determined and verified, the formula can be tailored to specific assets at specific points in time. Thus, carefully crafted applications of the Longstaff approach provide appraisers with a powerful tool for estimating (or challenging) discounts for lack of marketability.

Applications are available for producing a probability distribution based on inputs provided thereto and for performing a plurality of calculations based on a formula to generate data filling a spreadsheet or other form. For example, the Crystal Ball suite of applications can generate probability distributions and MICROSOFT EXCEL from the Microsoft Corporation of Redmond, Wash. provides spreadsheet functionalities. However, no known applications or devices provide the cross-functionality, interoperability, and extensibility required to provide a user with ways to calculate DLOM that take into account known price and marketing period data for guideline or benchmark assets, parameters and characteristics of those assets, and probability distributions generated from the asset data, among other data and functionalities.

There is thus a need in the art for a reliable method for calculating a DLOM when valuing an investment that is not immediately marketable. Such a method that takes into account a variety of variables and that is tailored to the characteristics of a particular asset to be valued as of a particular day would also be advantageous. There is also a need for computer-implemented applications and computing devices that aid users in generating such a DLOM quickly and easily based on a selected set of variables.

### SUMMARY

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter. In brief, this disclosure describes, among other things, methods, computer-readable media, and systems that provide ways to generate a discount for lack of marketability (DLOM) for an asset, such as a private business, that is useable in valuation of the asset. Methods, systems, and media are also described that perform ways of determining the effects of selected variables on the precision of the generated DLOM.

In one embodiment, a computer-executable application is provided that prompts a user for selection of a database that includes data associated with previously completed transactions for sales of assets. The user is also prompted for selection of one or more parameters associated with the asset and that are useable to identify subsets of data within the database and for an estimated price volatility of the asset.

A meanₜ and standard deviationₜ of the transaction periods associated with the transactions in the database are determined for the total population and for each subset defined by the selected parameters. Based on these calculations, an adjusted meanₜ and standard deviationₜ may be determined. A statistical modeling engine is employed to transform the unadjusted or adjusted meanₜ and standard deviationₜ into a probability distributionₜ indicating the probabilityₜ that the asset will sell at a given time.

A formula, such as a look back option pricing formula, is employed to determine a period-specific DLOMₜ for a plurality of time periods occurring within the time scale of the probability distributionₜ. The period-specific DLOMₜs are weighted using the probability associated therewith and defined by the probability distributionₜ and are combined to form a probability-weighted DLOMₜ for the asset. The probability-weighted DLOMₜ as well as a visualization of the probability distributionₜ, and one or more additional data elements are presented to the user via the user interface.

In another embodiment, a probability distribution of the price volatility for the asset is constructed and incorporated into determination of a double-probability-weighted DLOMₜᵥ. A selection of one or more assets for which price volatility information is available, e.g. publicly traded stocks, is received. A meanᵥ and standard deviationᵥ of price volatility for the selected assets is determined over a period of time. A statistical modeling engine is employed to transform the price volatility meanᵥ and standard deviationᵥ into a probability distributionᵥ indicating the probabilityᵥ that the asset will sell at a given price volatility. The probability distributionᵥ provides a plurality of price volatilities and their associated probabilityᵥ that the asset will sell at the respective price volatility.

The price volatility probabilitiesᵥ provided by the probability distribution are combined with the probabilitiesₜ that the asset will sell at a given time to generate an array of combined probabilitiesₜᵥ depicting the probability that the asset will sell at a given time and volatility. A combined DLOMₜᵥ for each time period occurring within the time scale of the time probability distributionₜ and for each of a plurality of volatilitiesᵥ in the price volatility probability distributionₜ is calculated. The combined DLOM_{TV}s are weighted using the combined probabilityₜᵥ associated therewith and are combined to form a double-probability-weighted DLOMₜᵥ for the asset. The double-probability-weighted DLOM as well as a visualization of the double-probability distributionₜᵥ and one or more additional data elements are presented to the user via the user interface.

In another embodiment, a precision engine is provided to aid a user in identifying the effect of selecting particular parameters on the overall precision of the data. The precision engine determines a coefficient of variation for each selected parameter based on the mean and standard deviation thereof. The coefficients of variation for each of the selected parameters are compared to the coefficient of variation of the population and combined to generate an overall precision. Based on this data the user can choose to include or exclude one or more of the selected parameters to tailor the precision of DLOM calculations based thereon.

### DESCRIPTION OF THE DRAWINGS

Illustrative embodiments of the invention are described in detail below with reference to the attached drawing figures, and wherein:

FIG. 1 depicts a compilation of data reported for selected published restricted stock studies;

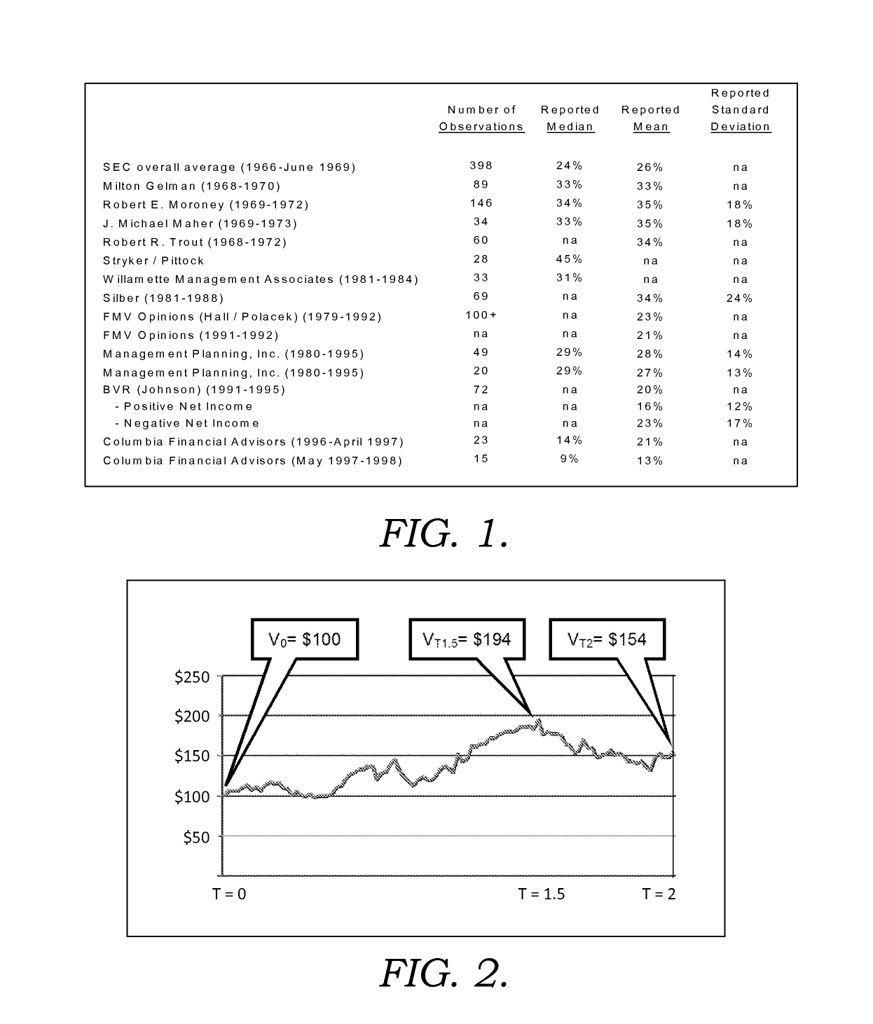

FIG. 2 is a graphical presentation depicting a value of a stock over a period of time;

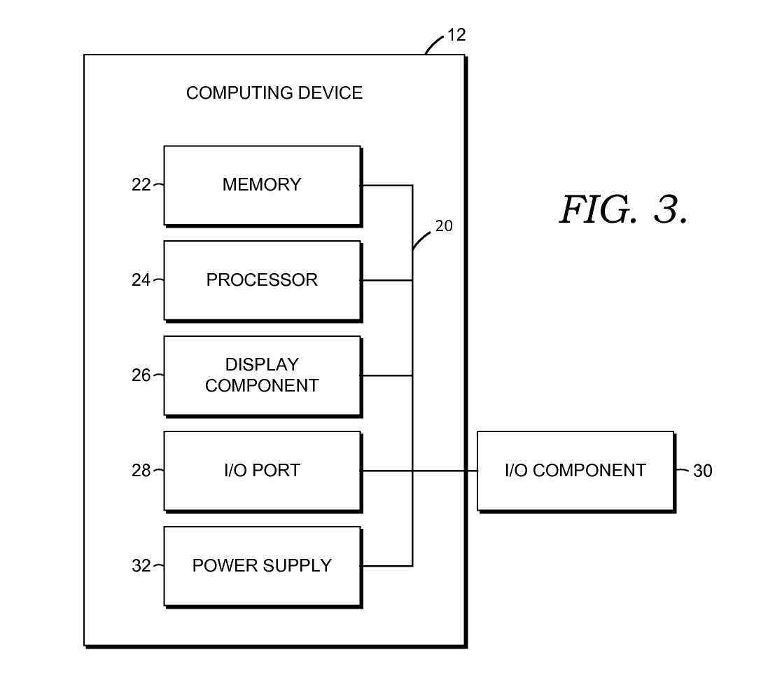

FIG. 3 is a block diagram depicting an exemplary computing device suitable for use in embodiments of the invention;

FIG. 4 is a block diagram depicting an exemplary networked operating environment suitable for use in embodiments of the invention;

FIG. 5 is a flow diagram depicting a method for providing a probability adjusted discount for lack of marketability for an asset based on marketing periods associated with the asset depicted in accordance with an embodiment of the invention;

FIG. 6 is a flow diagram depicting additional steps that may be employed in the method depicted in FIG. 5 in accordance with an embodiment of the invention;

FIG. 7 is a graphical representation of a probability distribution of marketing periods for an asset produced by a statistical modeling engine in accordance with an embodiment of the invention;

FIG. 8 is a flow diagram depicting additional steps useable with the method depicted in FIG. 5 in accordance with an embodiment of the invention;

FIG. 9 is a flow diagram depicting another method for providing a probability adjusted discount for lack of marketability for an asset based on marketing periods for the asset depicted in accordance with an embodiment of the invention;

FIG. 10 is an illustrative view of a user interface depicted in accordance with an embodiment of the invention;

FIG. 11 is a block diagram of a system for providing a probability adjusted discount for lack of marketability for an asset depicted in accordance with an embodiment of the invention;

FIG. 12 is a graphical representation of a probability distribution of marketing periods of a private business to be valued, the graphical representation produced by a statistical modeling engine in accordance with an embodiment of the invention;

FIG. 13 is a table of a selection of data elements represented by the graphical representation of FIG. 12;

FIG. 14 is a flow diagram of a method for obtaining price volatility data and generating a probability distribution based thereon in accordance with an embodiment of the invention;

FIG. 15 is a graphical representation of a probability distribution of price volatility for an asset to be valued generated by a statistical modeling engine in accordance with an embodiment of the invention;

FIG. 16 is a graphical representation of a probability distribution of marketing periods associated with an asset to be valued generated by a statistical modeling engine in accordance with an embodiment of the invention;

FIG. 17 is a flow diagram of a method for calculating a double-probability-weighted discount for lack of marketability based on price volatilities and marketing periods for an asset to be valued in accordance with an embodiment of the invention;

FIG. 18A is a table depicting a selection of data produced by the probability distributions of FIGS. 15 and 16 and combined probabilities generated therefrom;

FIG. 18B is a graphical representation of the combined probabilities generated based on the data depicted in FIG. 18A;

FIG. 19A is a table depicting a selection of data elements corresponding to the data elements of FIG. 18A and showing generation of a double-probability-weighted discount for lack of marketability in accordance with an embodiment of the invention;

FIG. 19B is a graphical representation of the double-probability-weighted discount for lack of marketability data elements of FIG. 20A;

FIG. 20 is a flow diagram depicting a computer-implemented method for generating, in real time or substantially in real time, a double-probability-weighted discount for lack of marketability in accordance with an embodiment of the invention;

FIG. 21 is an illustrative view of a user interface presented to a user for generating a double-probability-weighted discount for lack of marketability;

FIG. 22 is a flow diagram depicting a method for determining a precision associated with data set selected for determination of a discount for lack of marketability; and

FIGS. 23A-C are tables and corresponding graphical representations of a precision associated with each of a plurality of selected parameters employed for generation of a discount for lack of marketability for an asset.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

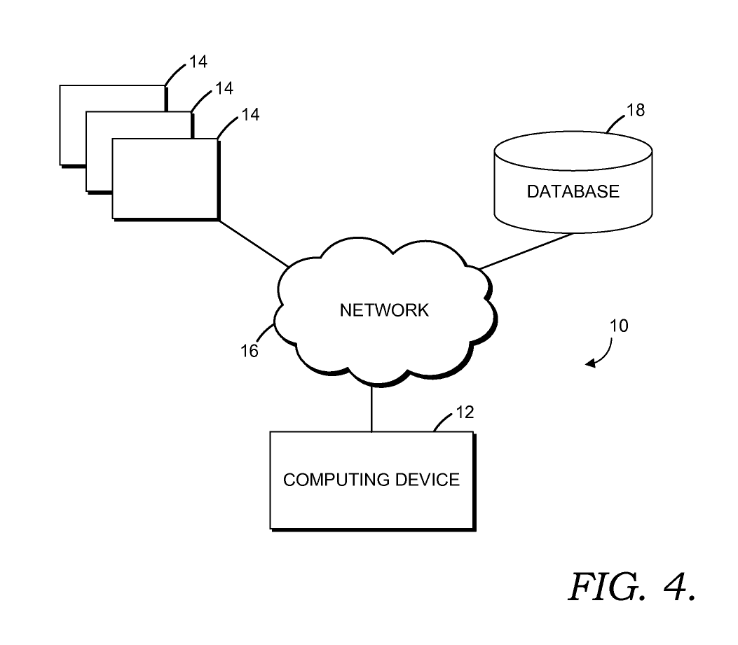

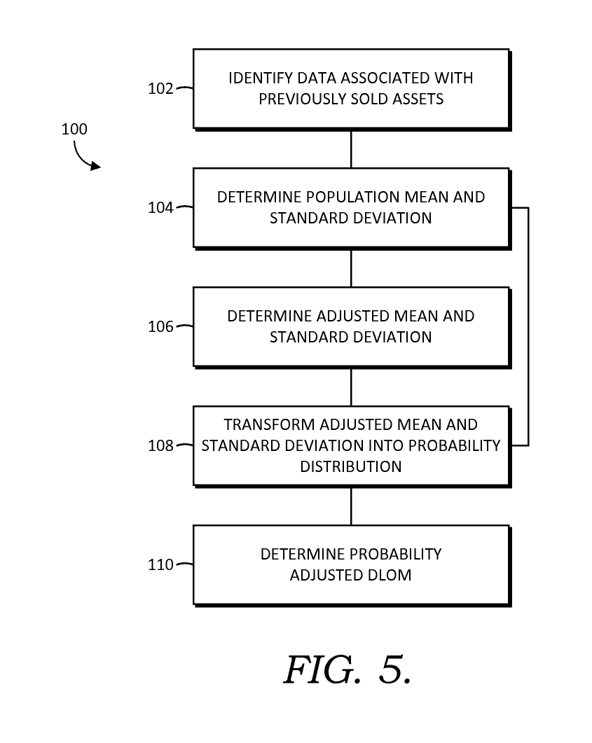

With initial reference to FIG. 3, an exemplary computing device 12 for implementing embodiments of the invention is shown in accordance with an embodiment of the invention. The computing device 12 is but one example of a suitable computing device and is not intended to suggest any limitation as to the scope of use or functionality of embodiments of the invention. The computing device 12 should not be interpreted as having any dependency or requirement relating to any one or combination of components illustrated. FIG. 4 depicts an exemplary operating environment 10 in which the computing device 12 may be disposed in a networked configuration. Although many components of the operating environment 10 and the computing device 12 are not shown or described herein, it is appreciated that such components and their interconnection are well known. Accordingly, additional details concerning the construction of the operating environment 10 and the computing device 12 are not further disclosed herein.

Embodiments of the invention may be practiced in a variety of system configurations, including hand-held devices, consumer electronics, general-purpose computers, specialty computing devices, and the like. The computing device 12 is inclusive of devices referred to as workstations, servers, desktops, laptops, hand-held device, and the like as all are contemplated within the scope of FIGS. 3 and 4 and in references to the computing device 12.

Embodiments of the invention may be practiced by a stand-alone computing device as depicted in FIG. 3 and/or in distributed computing environments where one or more tasks are performed by remote-computing devices 14 that are linked through a communications network 16 (FIG. 4). The remote-computing devices 14 comprise one or more computing devices that may be configured like the computing device 12. An exemplary computer network 16 may include, without limitation, local area networks (LANs) and/or wide area networks (WANs). Such networking environments are commonplace in offices, enterprise-wide computer networks, intranets and the Internet. When utilized in a WAN networking environment, the computing device 12 may include a modem or other means for establishing communications over the WAN, such as the Internet. In a networked environment, program modules or portions thereof may be stored in association with the computing device 12, a database 18, or one or more remote-computing devices 14. For example, and not limitation, various application programs may reside on memory associated with any one or more of the remote-computing devices 14. It will be appreciated that the network connections shown are exemplary and other means of establishing a communications link between the computers (e.g., the computing device 12 and the remote-computing devices 14) may be utilized.

Embodiments of the invention may be described in the general context of computer code or machine-useable instructions, including computer-executable instructions, such as program modules being executed by a computer or other machine, like a smartphone, tablet computer, or other device. Generally, program modules including routines, programs, objects, components, data structures, or the like, refers to code that performs particular tasks or implements particular abstract data types.

With continued reference to FIG. 3, the computing device 12 includes one or more system busses 20, such as an address bus, a peripheral bus, a local bus, a data bus, or the like, that directly or indirectly couple components of the computing device 12. The bus 20 may comprise, for example, an Industry Standard Architecture (ISA) bus, Micro Channel Architecture (MCA) bus, Enhanced ISA (EISA) bus, Video Electronic Standards Association (VESA) local bus, a Peripheral Component Interconnect (PCI) bus, among other bus architectures available in the art.

The bus 20 couples components like internal memories 22, processors 24, display components 26, input/output (I/O) ports 28 and I/O components 30 coupled thereto, and a power supply 32. Such components may be provided singly, in multiples, or not at all as desired in a particular configuration of the computing device 12. As indicated previously, additional components might also be included in the computing device 12 but are not shown or described herein so as not to obscure embodiments of the invention. Such components are understood as being within the scope of embodiments of the invention described herein.

The memory 22 of the computing device 12 typically comprises a variety of non-transitory computer-readable media in the form of volatile and/or nonvolatile memory that may be removable, non-removable, or a combination thereof. Computer-readable media include computer-storage media and computer-storage devices and are mutually exclusive of communication media, e.g. carrier waves, signals, and the like. By way of example, and not limitation, computer-readable media may comprise Random Access Memory (RAM); Read-Only Memory (ROM); Electronically Erasable Programmable Read-Only Memory (EEPROM); flash memory or other memory technologies; compact disc read-only memory (CDROM), digital versatile disks (DVD) or other optical or holographic media; magnetic cassettes, magnetic tape, magnetic disk storage or other magnetic storage devices, or any other medium that can be used to encode desired information and be accessed by the computing device 12.

The processor 24 reads data from various entities such as the memory 22 or the I/O components 30 and carries out instructions embodied thereon or provided thereby.

The display component 26 presents data indications to a user or other device. Exemplary presentation components include a display device, a monitor, a speaker, a printing component, a vibrating component, or other component that produces an output that is recognizable by a user.

The I/O ports 28 allow the computing device 12 to be logically coupled to other devices including the I/O components 30, some of which may be built in. Illustrative components include a microphone, joystick, game pad, satellite dish, scanner, printer, or wireless device, among others.

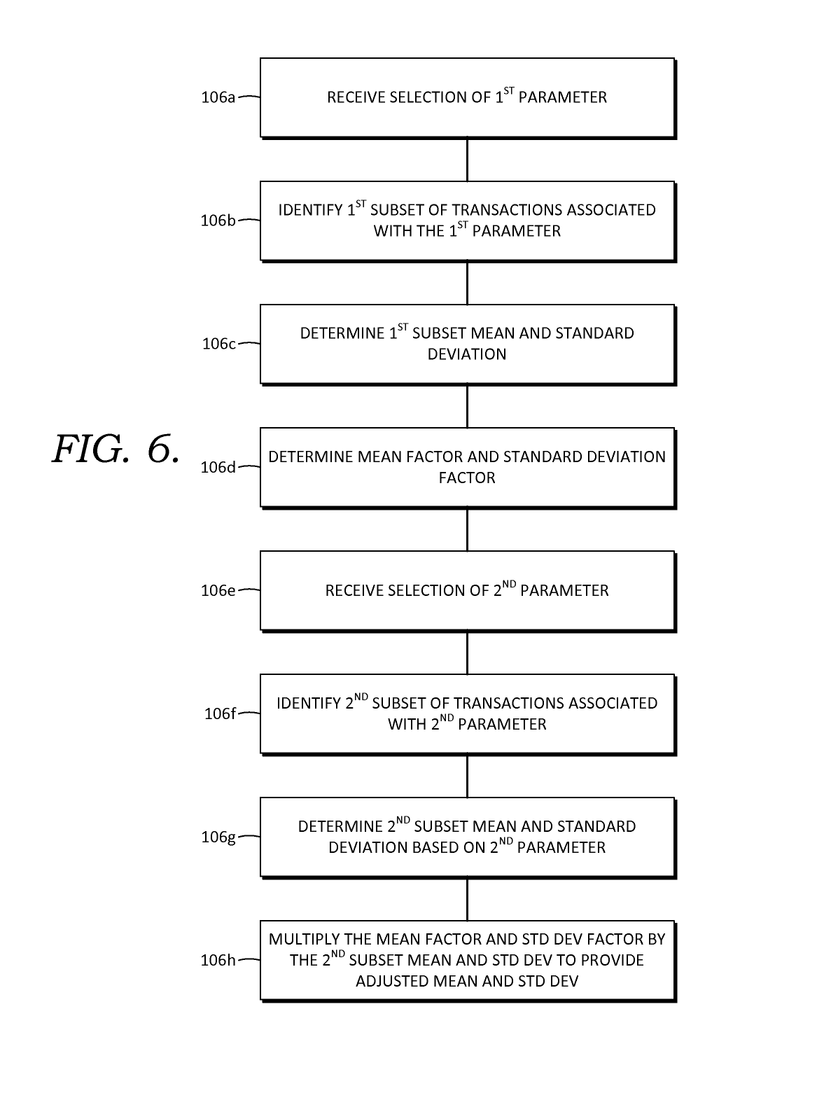

With reference now to FIG. 5, a method 100 for providing a probability adjusted discount for lack of marketability (DLOMₜ) for an asset based on marketing period probabilities is described in accordance with an embodiment of the invention. A subscript “t” is used herein to indicate that a value is determined based on time or probabilities associated with time, e.g. marketing period, and a subscript “v” indicates a value determined based on a price volatility or probability of a price volatility. As described herein, the asset being valued comprises a privately held business. However, such is not intended to so limit embodiments of the invention which can be applied to any of a variety of assets for which historical transactional data is available, such as, for example and not limitation, intangible assets, real estate, commodities, publicly traded businesses, or restricted stock shares, among many possible applications.

At step 102, data associated with a plurality of transactions for the sale of a population of previously sold assets is identified. The transactions comprise previously closed sales transactions for which at least a listing date and a closing date are available; an indication of a transaction period, e.g. a time between the listing date and the closing date, might also be provided instead of or in addition to the actual listing and closing dates. The listing dates preferably include a month and year of listing of the asset for sale. The data may include a listing price for the asset and an industry classification for the asset, such as a codification of the asset under the Standard Industrial Classification (SIC) system, International SIC (ISIC) system, North American Industry Classification System (NAICS), or Global Industrial Classification Standard (GICS), among others. Data reflecting additional parameters, like a number of employees, number of years in business, annual revenue, operating profit, earnings, total assets, stockholder's equity, MLS (multiple listing service) data, a geographic location of the asset, a rating of the physical or financial condition of the asset, or an indication of the state or nation governing the asset, among other parameters might also be provided.

The transaction data is identified in and/or obtained from a database, such as the database 18, or other storage location. The transaction data may be provided by a third party, such as a party that is in the business of collecting, managing such transactional data. Exemplary transaction data sources include PRATT'S STATS, a database of mergers and acquisitions transactions data provided by Business Valuation Resources of Portland, Oreg.; BIZCOMPS, a database of small business transactions sales data provided by Bizcomps of Las Vegas, Nev.; IBA Market Data, a database of sales transaction data for small to medium businesses provided by The Institute of Business Appraisers of Salt Lake City, Utah; and DoneDeals, a database of mid-market business sales transactions provided by ValuSource of Colorado Springs, Colo. Data sources exist for other assets as well, such as the Multi-Listing Service (“MLS”) maintained by the National Association of Realtors. The database 18 can be remotely located and accessed via a network, such as the network 16, or can be housed locally and accessible directly by a user's computing device, e.g. the computing device 12. Alternatively, values calculated from the data sources can be input into the database 18 or other storage location, thereby eliminating the need to repeatedly directly access the transactions databases to obtain values.

A population meanₜ and standard deviationₜ of the transaction periods are determined from the group of all of the transactions identified in the database at step 104. The population meanₜ and standard deviationₜ may then be adjusted to provide an adjusted meanₜ and an adjusted standard deviationₜ of the transaction periods for the transactions described in the transaction data as indicated at step 106. To determine the adjusted meanₜ and standard deviationₜ, the transaction data may be analyzed to identify trends or characteristics in the data for sold assets that have similarities with the asset to be valued. The meanₜ and standard deviationₜ of the population can thus be adjusted to account for those trends or other characteristics. In one embodiment, the meanₜ and standard deviationₜ of the population of sale transactions can be used in furtherance of the invention without adjustment.

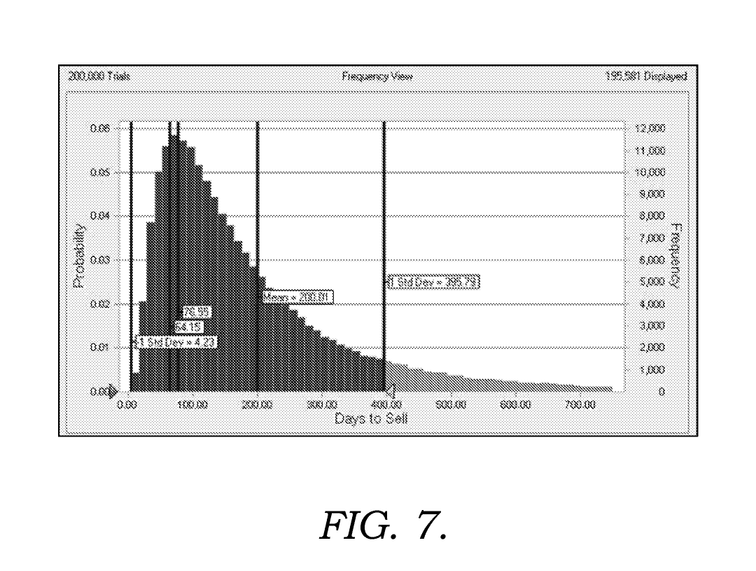

For example, with additional reference to FIG. 6, additional parameters or characteristics of the asset to be valued can be employed to aid analysis of the transaction data and/or to identify subsets of the transaction data for use in adjusting the population meanₜ and standard deviationₜ in accordance with an embodiment of the invention. A selection of a first parameter for the asset is received at step 106a. The first parameter includes a characteristic of the asset to be sold/valued, like, for example, an SIC codification of the asset, a listing price of the asset, a month in which the asset is listed for sale, or a year in which the asset is listed for sale, among a variety of other characteristics for which data is included in the transactional data.

A subset (first subset) of the transactions represented in the transaction data that includes the first parameter, e.g. transactions for sold assets having matching SIC codes, is identified as indicated at step 106b. The meanₜ and standard deviationₜ of the transaction periods for the transactions comprising the first subset are determined as indicated at step 106c. The meanₜ and standard deviationₜ of the first subset may be employed in furtherance of the invention without additional adjustment. Or the meanₜ and standard deviationₜ of the first subset may be utilized to generate a mean factor and a standard deviation factor as indicated at step 106d. The mean factor is equal to the first subset meanₜ divided by the population meanₜ and the standard deviation factor equals the first subset standard deviationₜ divided by the population standard deviationₜ.

A selection of a second parameter, such as a listing price, month of listing, or year of listing, is received at step 106e. A second subset of the transaction data including transactions for sold assets sharing the second parameter is identified at step 106f and the meanₜ and standard deviationₜ for the transaction periods of the transactions comprising the second subset are determined as indicated at step 106g. The second subset meanₜ and standard deviationₜ are next multiplied by the mean factor and standard deviation factor, respectively, to generate the adjusted meanₜ and the adjusted standard deviationₜ as indicated at step 106h. Any number of additional parameters may also be employed in a similar manner, e.g. by determining a meanₜ and standard deviationₜ of a subset associated with the selected additional parameter, dividing by the population meanₜ and standard deviationₜ, respectively, to generate factors that are then multiplied by the previously calculated adjusted meanₜ and standard deviationₜ as described above.

Returning to FIG. 5, the adjusted meanₜ and standard deviationₜ of the transaction periods for the sold assets are provided to a statistical modeling engine or application. The statistical modeling engine is any one or more modeling engines that are useable to generate a statistical probability distribution indicating the probability that the asset to be valued will sell in a given period of time based on the adjusted meanₜ and adjusted standard deviationₜ (or on the unadjusted meanₜ and standard deviation) provided thereto. For example, the statistical modeling engine may comprise one or more components of the Crystal Ball suite of modeling applications from the Oracle Corporation and may employ any available simulation or forecasting methodologies, such as Monte Carlo simulations and time-series forecasting. Other mathematical and statistical modeling tools or software such as R, an open source computing language and environment for statistical computing and graphics, or GNU S a similar open source language, may alternatively be used or programmed to determine probability distributions. The statistical modeling engine transforms the adjusted meanₜ and standard deviationₜ into a probability distributionₜ depicting the probability that the asset to be valued will sell with respect to a length of the transaction period as indicated at step 108.

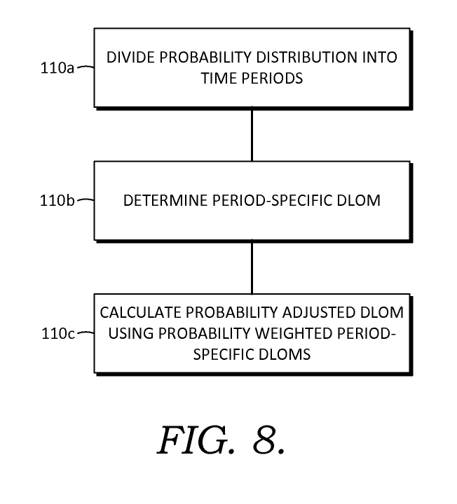

The probability distributionₜ is preferably provided on a natural logarithmic scale (e.g. the logarithm with the base e, where e is approximately equal to 2.71828182845904 or Euler's number) but can employ a base ten logarithmic scale, or other logarithmic or non-logarithmic scale as desired. A graph of an exemplary probability distribution based on a natural logarithmic scale is depicted in FIG. 7.

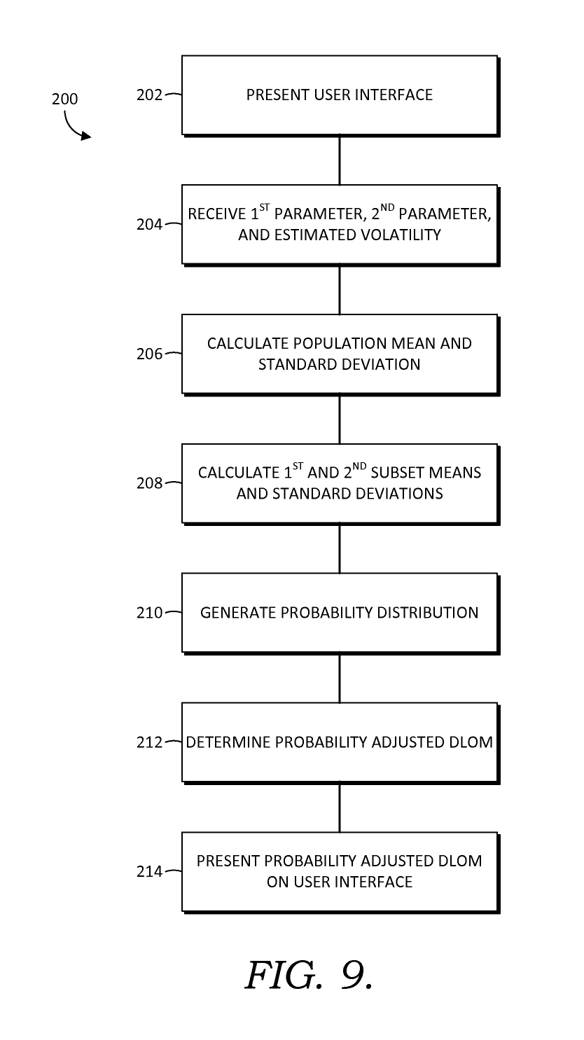

As indicated at FIG. 8, step 110a, the probability distributionₜ is employed to determine a probability-weighted DLOMₜ for the asset to be valued. A formula, based on the Longstaff model, such as that depicted above, or a variation thereof is preferably employed to calculate the DLOMₜ for the asset to be valued. Other available models and/or formulas, like other look-back models or various option pricing models might be employed to determine a DLOMₜ for the asset. The calculated DLOMₜ is adjusted based on the probability that the asset will sell in a given transaction period as depicted by the probability distributionₜ.

With additional reference to FIGS. 7-8, the calculated DLOMₜ may be adjusted by first dividing the total transaction period depicted by the probability distributionₜ into a plurality of time segments. Such time segments may consist of periods of equal length of time, equal probability of occurrence among the sale transactions, or otherwise. An upper bound may be placed on the range of distributed transaction periods, e.g. an upper bound might be applied at a transaction period value at or below which the asset is 95% likely to sell, or within a transaction period that is one standard deviation above the mean of the probability distributionₜ, or some other determined limitation.

The total transaction period is divided into any number of time segments that may be equal in length or may vary in length. In one embodiment, the total transaction period is divided based on the cumulative probability associated with the time segments, e.g. a first time segment is defined between time zero and up to a time T₁ when the cumulative probability represented by the probability distributionₜ is equal to 1% and a second time period is defined between time T₁ and a time T₂ at which the cumulative probability is equal to 2%.

A representative time value is selected for each time segment, e.g. the midpoint, initial point, or end point of each time segment is selected. Alternatively, a plurality of representative time values might be selected without reference to particular time segments of the total transaction period. A probability associated with each of the representative time values is identified from the probability distributionₜ. The probabilities may be adjusted based on the upper bound to recalibrate the total of the probabilities to 100%, e.g. if the upper bound is placed at the transaction period within which the asset is 95% likely to sell, then the probabilities associated with each of the segments can be multiplied by approximately 1.053 (e.g. 100%/95%) such that the sum of the probabilities is equal to 100.

The representative time value for each of the segments is input into the chosen DLOMₜ formula along with any other needed inputs, e.g. the estimated price volatility of the asset, to calculate a period-specific DLOMₜ for each of the time segments as indicated at step 110b. More than one estimated price volatility may constitute an input, e.g. a separate price volatility could be estimated for each determined time period. Each of the period-specific DLOMₜs is next weighted based on the probabilities depicted by the probability distributionₜ (or as adjusted to accommodate for an upper bound) by multiplying the period-specific DLOMₜs by the probability associated with the respective period. The probability-weighted DLOMₜ for the asset is calculated by summing the probability-weighted period-specific DLOMₜs as indicated at step 110c. It is understood that one of skill in the art may identify alternative ways or variations of the steps described above that are useable to calculate the probability-weighted DLOMₜ; those alternatives and/or variations are within the scope of embodiments of the invention described herein.

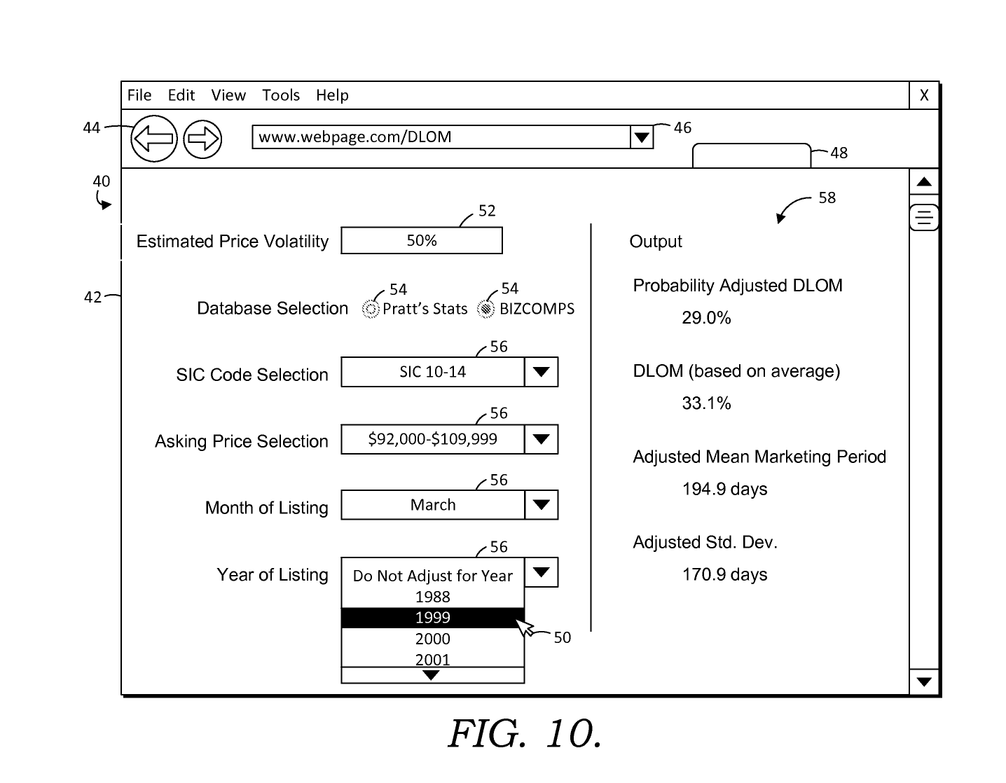

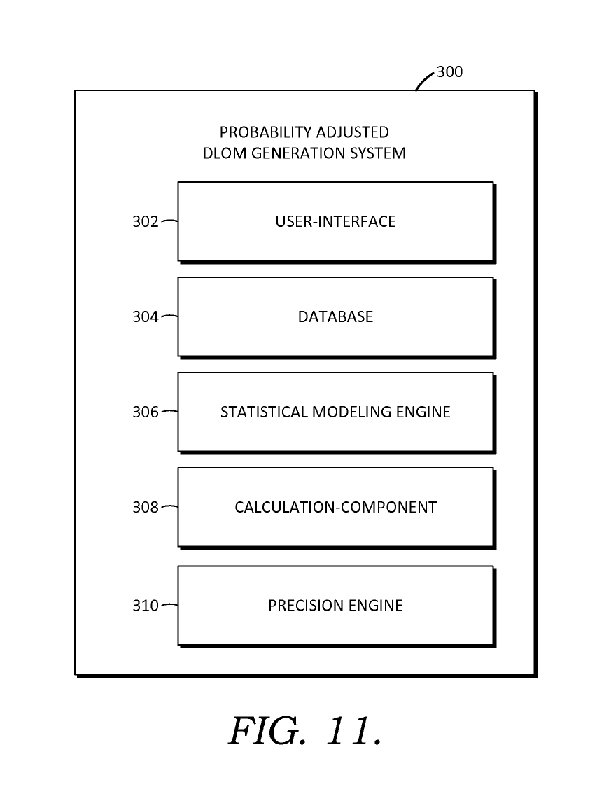

Referring now to FIGS. 9-10, a method 200 for providing a probability adjusted DLOMₜ for an asset based on marketing period probabilities is described in accordance with an embodiment of the invention. At step 202, a user interface is provided, such as for example the user interface 40 depicted in FIG. 10. The user interface 40 is provided on one or more display devices 26 associated with the computing device 12, as depicted in FIG. 3. The user interface 40 may be provided via the Internet or other network 16 or is generated by an application that is resident on the computing device 12. The user interface 40 is presented in a window 42 which may include one or more control features 44, input fields 46, tabs 48, a pointer 50, or similar features known in the art.

The user interface 40 also includes a plurality of fields 52, 54, 56 in which data associated with the asset to be valued can be input. The fields 52, 54, 56 can be configured in any available manner to enable direct entry of data or selection from one or more available options. For example, the input field 52 allows a user to directly enter an estimated price volatility for the asset by typing a number into the field 52, the fields 54 comprise selectable radio buttons that are selectable by the user to indicate a desired database from which to obtain transaction data, and the fields 56 comprise drop-down menus that allow the user to select parameters associated with the asset. The user interface 40 includes an output portion 58 that is presented alongside the input fields 52, 54, 56 or that can be presented on a separate page, or otherwise, as known in the art. The output portion 58 provides data elements calculated based on the inputs provided to the user interface 40, such as the probability-weighted DLOMₜ for the asset, one or more DLOMs calculated based on other available DLOM formulae, and an adjusted mean and standard deviation, among a variety of other outputs available in the art. In one embodiment, the output portion 58 provides a visualization or one or more graphs, like, for example, the graph depicted in FIG. 7, depicting the probability distributionₜ, time segments, and/or other available data thereon.

Returning to FIG. 9, one or more parameters and an estimated price volatility for the asset are received from the user via the user interface 40. As discussed previously, the parameters might include one or more of an SIC code, listing price, listing month, listing year, number of employees, years in business, annual revenue, operating profits, earnings before taxes, total assets, or stockholder's equity, among a variety of others. A selection of a desired database from which to identify or gather transaction data for previously sold assets may also be received. A population meanₜ and standard deviationₜ for transaction data in the selected database are calculated at step 206. Subset meansₜ and standard deviationsₜ are calculated for each of the selected parameters based on subsets of the transaction data identified using the selected parameter values at step 208.

In one embodiment, the calculations using the transaction data may be precompiled and/or cached in advance and the meanₜ and standard deviationₜ selected via the user interface retrieved from a memory location at runtime rather than being calculated at runtime. For example, a meanₜ and standard deviationₜ of all of the available parameters can be compiled in advance and their values stored for access at runtime. An adjusted meanₜ and standard deviationₜ may be determined using one or more factors calculated using the population meanₜ and standard deviationₜ and the meanₜ and standard deviationₜ of one or more of the parameters as described previously.

At step 210, a probability distributionₜ is generated by a statistical modeling application using the adjusted meanₜ and standard deviationₜ. The probability distributionₜ depicts a probability that the asset will sell with respect to time. A probability-weighted DLOMₜ for the asset is calculated based on the probability distributionₜ as indicated at step 212. The probability-weighted DLOMₜ can be determined, for example, by dividing the probability distributionₜ into a plurality of time segments, calculating a period-specific DLOMₜ for each of the time segments, weighting the period-specific DLOMₜ for each segment based on the probability associated with the time segment depicted by the probability distributionₜ, and summing the weighted period-specific DLOMₜs.

At step 214, the probability-weighted DLOMₜ is presented to the user via the user interface 40. A variety of other calculations, such as DLOM calculations by other methods available in the art, may be performed by the computing device 12 and their results presented along with the probability-weighted DLOMₜ on the user interface 40. One or more graphics, visualizations, or other representations of the probability distributionₜ, the probability-weighted DLOMₜ, or other data may also be presented on the user interface 40. In one embodiment, a purchase or payment from the user is required and/or requested by the user interface 40 before the presentation of the probability-weighted DLOMₜ thereon. An additional screen, page, pop-up window or the like may be presented to prompt the user for payment information as known in the art.

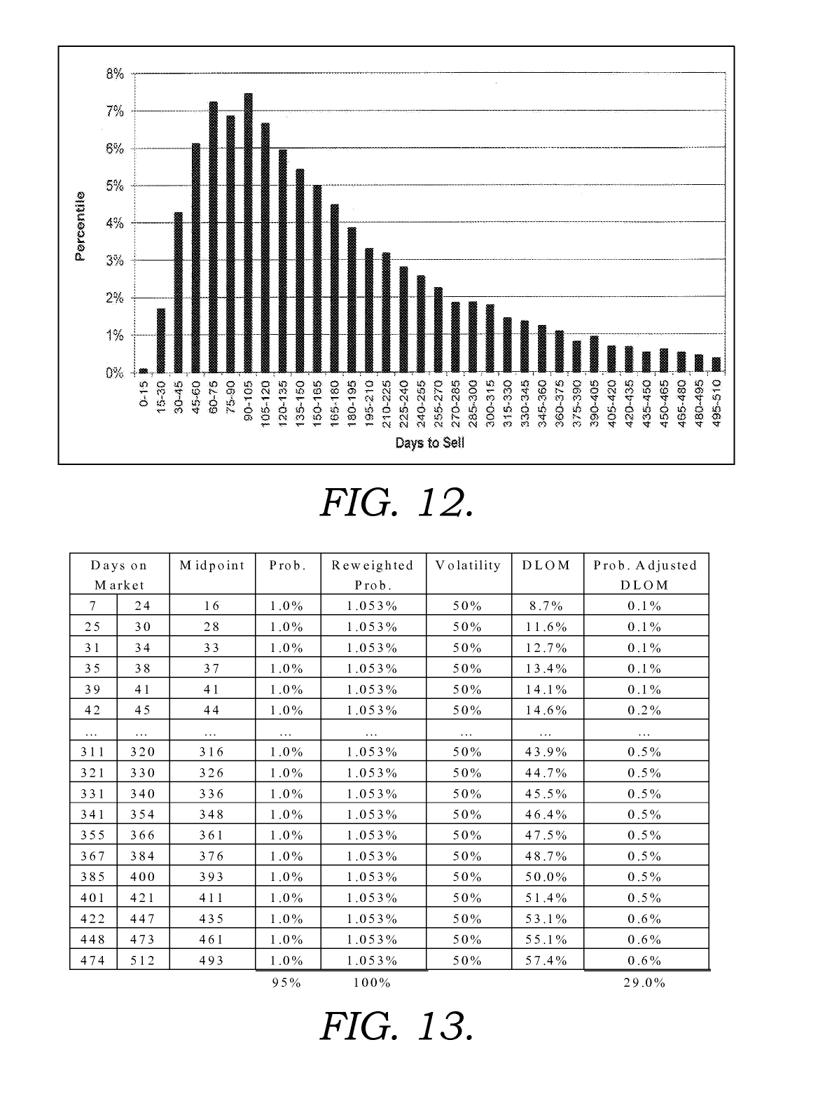

With reference to FIG. 11, a system 300 for providing a probability adjusted DLOMₜ for an asset based on marketing period probabilities is described in accordance with an embodiment of the invention. The system 300 includes a user interface 302, a database 304, a statistical modeling engine 306, and a calculation-component 308. The user interface 302 may be similar to the user interface 40 described previously above and is presented on a display device, like the display component 26, to prompt a user for inputs and to provide outputs thereto.

The database 304 comprises a non-transitory computer memory or storage (like, for example, the database 18) that includes a plurality of transaction data elements from a plurality of previously completed sales of assets. The database 304 may be provided by a third party or may be resident on the user's computing device or a computing device accessed by the user via a network, e.g. the computing device 12 and the network 16.

The statistical modeling engine 306 may similarly be provided by a third party on a remote computing system that is accessible via a network or may be resident on the user's computing device or a computing device accessed thereby. In one embodiment, the statistical modeling engine 306 comprises one or more components of the Crystal Ball suite of applications provided by Oracle Corporation. In another embodiment, the statistical modeling engine 306 includes a server computer executing one or more applications, such as an application running in a R environment configured to perform statistical modeling and graphics generation.

The statistical modeling engine 306 is configured to generate a probability distributionₜ depicting the likelihood that an asset will sell with respect to time based on a meanₜ and a standard deviationₜ of transaction periods in which other assets have previously sold. In one embodiment, the statistical modeling engine 306 generates a probability distributionᵥ based on a meanᵥ and standard deviationᵥ of price volatilities of the asset as described more fully below. The engine 306 and/or the generation of the probability distributionₜ may be configurable based on a variety of variables including, for example, a number of trials or iterations to be considered by the engine 306, among others.

The calculation-component 308 may comprise the user's computing device or a computing device accessed thereby and is configured to generate a probability-weighted DLOM based on the probability distribution returned by the statistical modeling engine 306 using methods as described herein. In one embodiment, the calculation-component 308 is configured to calculate the probability-weighted DLOM in, or substantially in, real time or at runtime, e.g. to complete hundreds or thousands of calculations involved in generating the probability-weighted DLOM in a time span of less than a few minutes or seconds. The calculation-component 308 may also calculate one or more additional data elements such as a DLOM produced using another formula available in the art and/or an adjusted meanₜ and standard deviationₜ for the asset based on the transaction data, among others. In one embodiment, the calculation component 308 calculates and caches a meanₜ and standard deviationₜ for the population and for subsets of the population of transaction data based on one or more parameters; the cached data is then subsequently useable on demand without requiring calculation thereof at runtime.

The system 300 may also include a precision engine 310. The precision engine 310 is executable by the computing device to provide an indication of the effect that selection of one or more parameters has on the precision of the data associated with the population of previously sold assets employed to generate the probability distribution.

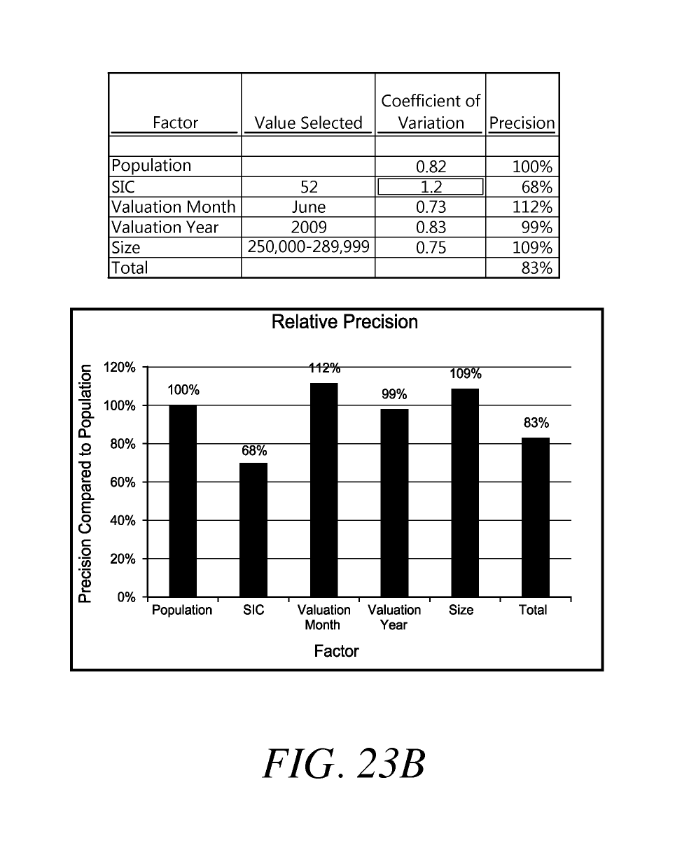

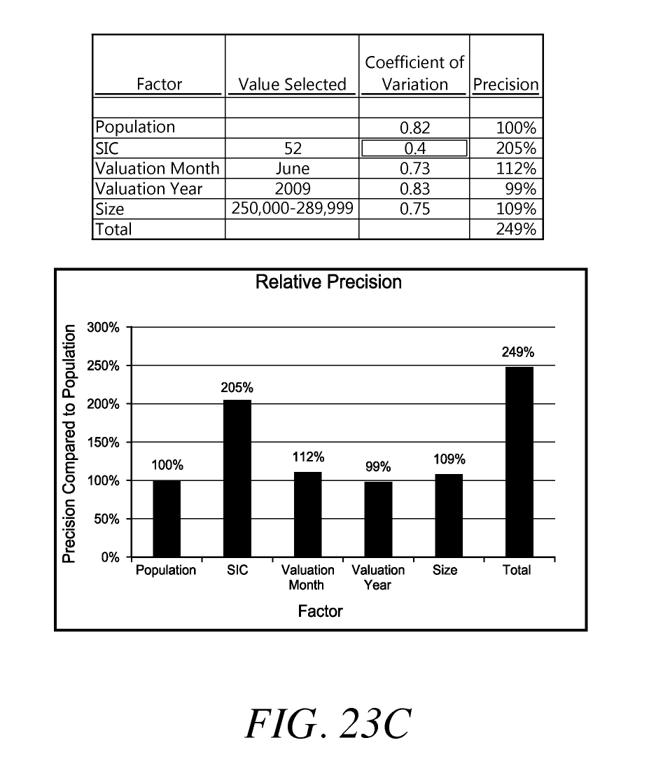

With reference to FIGS. 22 and 23A-C, a method 800 for providing a relative precision of a group of selected parameters associated with data for previously sold assets is described in accordance with an embodiment of the invention. Initially, a population of data associated with previously sold assets is identified. A coefficient of variation of the population is determined at step 802. In one embodiment, the coefficient of variation of the population is equal to the standard deviation of the population divided by the mean of the population. As depicted in FIGS. 23A-C, the exemplary coefficient of variation of the population is equal to 0.82.

At step 804 selection of one or more parameters is received. As shown in FIG. 23A, an SIC code, a valuation month, a valuation year, and a business size parameter have been selected and values thereof input. A coefficient of variation of each of the selected parameters is determined using the same formula employed for the population at step 806. A precision is determined for each of the selected parameters at step 808 by dividing the coefficient of variation of the population by the coefficient of variation of each respective parameter. A cumulative or total precision is then calculated by finding the absolute value of the product of the precision values at step 810. A graphical illustration of the precision values may be constructed and presented to a user at step 812.

The user is thus provided with an indication of whether selection of one or more of the parameters increases or decreases the precision of the calculation of the DLOM for the asset to be valued. A total precision value that is greater than 100%, e.g. greater than the precision of the population alone, indicates that the selected parameters have increased the overall precision of the data. For example, FIG. 23B depicts an instance in which data associated with previous sales of assets with an SIC code of 52 have a high variability and thus a high coefficient of variation. Inclusion of SIC code 52 as a parameter (along with the values of the other selected parameters) thus lowers the precision of from 100% for the population alone to 83%. As shown in FIG. 23B the remaining parameters have precision values nearly equal or greater than the population. As such, the user may elect to not include SIC code as a parameter for this calculation. The precision engine also provides the user with evidence for substantiating their inclusion or exclusion of the parameter from the DLOM calculations.

In another instance depicted in FIG. 23C, the data associated with SIC code 52 is shown to have a high precision. Inclusion of SIC code 52 in this instance thus greatly increases the overall precision of the calculations as shown by the graphical illustration provided in FIG. 23C. Users will thus likely want to include SIC code in the selected parameters and are provided with strong evidence to substantiate their reasoning for doing so. The precision engine can be used in similar manner to evaluate the effect of including or excluding certain data sources for determining price volatility.

With reference now to FIGS. 9, 12, and 13, an exemplary application of an embodiment of the invention is described with respect to an illustrative asset comprising a privately held business to be valued. A user interface, such as the user interface 40 is provided to a user via a web-based service that is accessible by the user's computing device. An estimated price volatility of 50% is received as an input along with a selection of a BIZCOMP database from which to obtain transaction data associated with previously sold assets. Parameters are selected indicating that the two-digit SIC code for the business is in the range of 10-14, the listing price of the business falls in the range of $92,000-$109,999, and that the listing date for the business is in March of the year 1999. Subsets of the transactions included in the BIZCOMP database are identified based on each of the parameter values. The subsets may overlap or may be mutually exclusive. Meanₜs and standard deviationₜs are determined for the total population and for each of the subsets of the transaction data. And an adjusted meanₜ and standard deviationₜ are determined therefrom using methods described previously above.

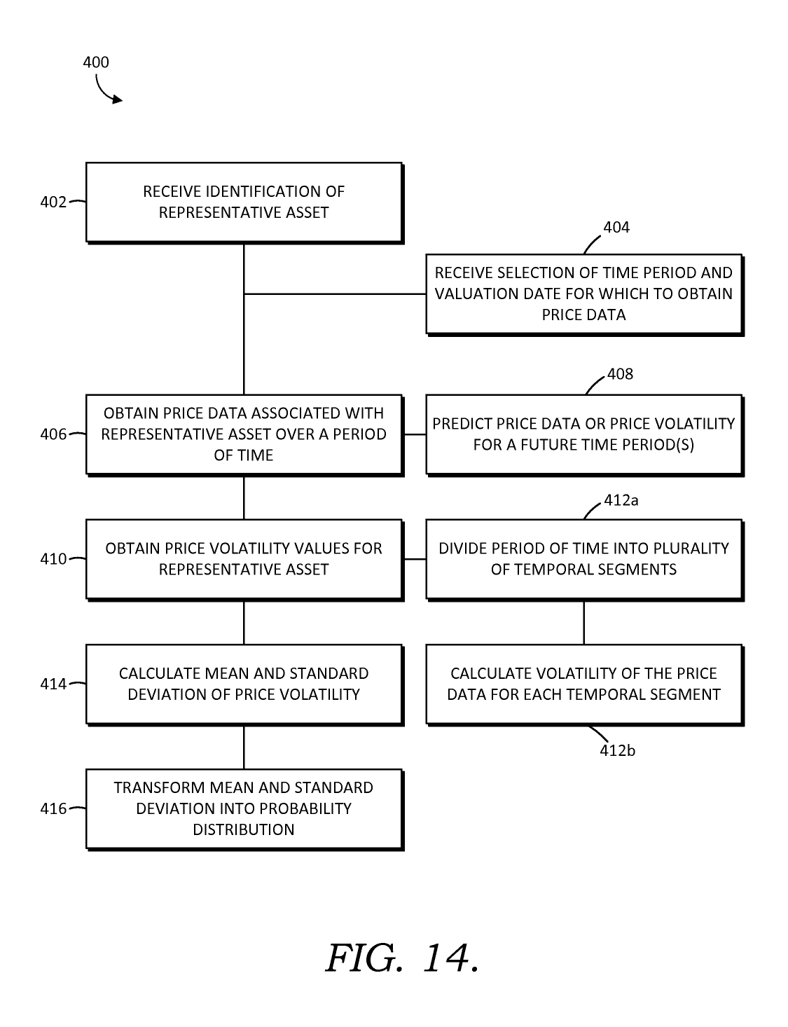

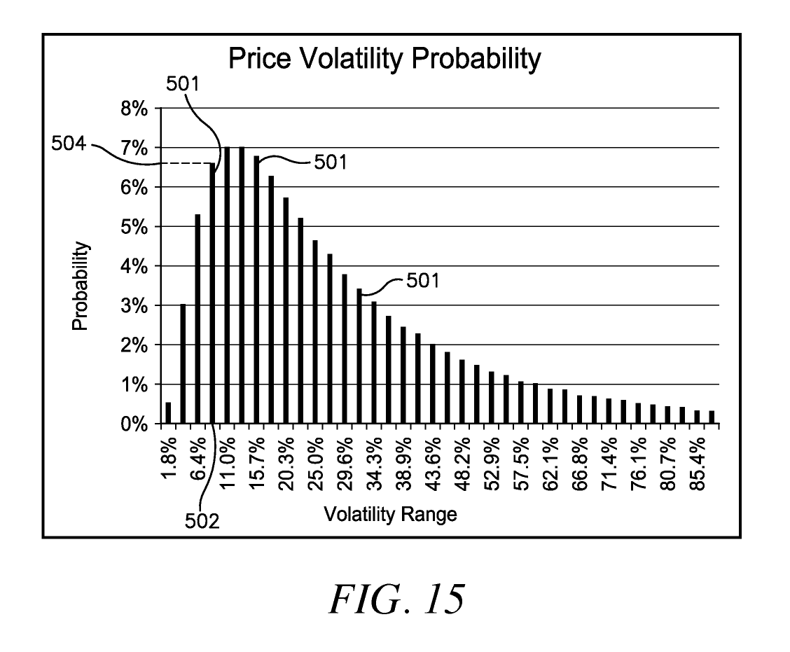

The adjusted meanₜ and standard deviationₜ are provided to the statistical modeling engine to produce a probability distributionₜ depicting the probability that the business will sell with respect to time. A graphical representation of the data representing the probability distributionₜ produced by the statistical modeling engine is depicted in FIG. 12 and FIG. 13 depicts a selection of the data in a table format. An upper bound is placed on the probability distributionₜ at a time or transaction period equal to about 512 days, which represents the point at which the asset has a 95% probability of being sold. As depicted in FIG. 12, the curve of the probability distributionₜ appears to be asymptotic as it extends toward very large time values; these large time values may thus be considered to be unlikely and/or irrelevant because assets typically do not require such long transaction periods to sell.

As depicted in FIG. 13, the probability distributionₜ is divided into time segments that correlate with each cumulative percentage point of the probability depicted by the probability distributionₜ. As such, the time segments are not uniform, e.g. do not include an equal amount of time, but represent an equal percentage of the population. (Alternatively, the percentage of the population that occurs in corresponding time periods of equal length will provide substantially the same result.) A midpoint is determined for each time segment, however an initial time, ending time, or other time value within the time segment could be employed; the midpoints shown in FIG. 13 may exhibit some rounding error. The probabilities are also reweighted to apply a scale based on 100% rather than the 95% scale (corresponding to 512 day transaction period) that results from applying the statistical modeling engine. Other forms of weighting, including no weighting, could be substituted for the described procedure.

With continued reference to FIG. 13, the previously described formula based on the Longstaff look-back model:

$$DLOM = V ( 2 + \frac{{σ}^{2} T}{2} ) N ( \frac{\sqrt{{σ}^{2} T}}{2} ) + V \sqrt{\frac{{σ}^{2} T}{2 π}} exp ( - \frac{{σ}^{2} T}{8} ) - V$$

is employed along with the estimated price volatility (σ) and the midpoint (T) to determine a DLOMₜ for each time segment, e.g. a period-specific DLOMₜ. The period-specific DLOMₜs are next multiplied by their respective probabilities depicted in the probability distributionₜ to produce a probability-weighted DLOMₜ. The probability-weighted DLOMs for all of the time segments are summed to produce a probability-weighted DLOMₜ for the asset equal to 29.0%.

As shown in FIG. 10, the resulting probability-weighted DLOMₜ, as well as the adjusted meanₜ and the adjusted standard deviationₜ, are provided to the user via the user interface 40. A DLOM calculated using known averaging methods may also be provided to allow the user to compare with the probability-weighted DLOMₜ. A graphical representation of the probability distributionₜ like that depicted in FIG. 12 can also be provided on the user interface 40. Other available materials such as reference materials explaining the methodologies used to calculate the probability-weighted DLOMₜ or links thereto may also be provided on the user interface 40. The user may be prompted for a payment at any time, including pursuant to a single-user or multiple-user subscription; prior to the computing device making calculations; prior to presentation of the generated data and/or any additional materials to the user; or otherwise.

In other embodiments of the invention a second variable in the DLOM calculation—the price volatility—can be employed to refine the resulting DLOM or to produce an alternative DLOM. The calculations can be conducted using a single estimated marketing period applied to a range of price volatilities, or methods like those described above for a range of marketing periods can be combined with a range of price volatilities to produce a double-probability-weighted DLOMₜᵥ based thereon.

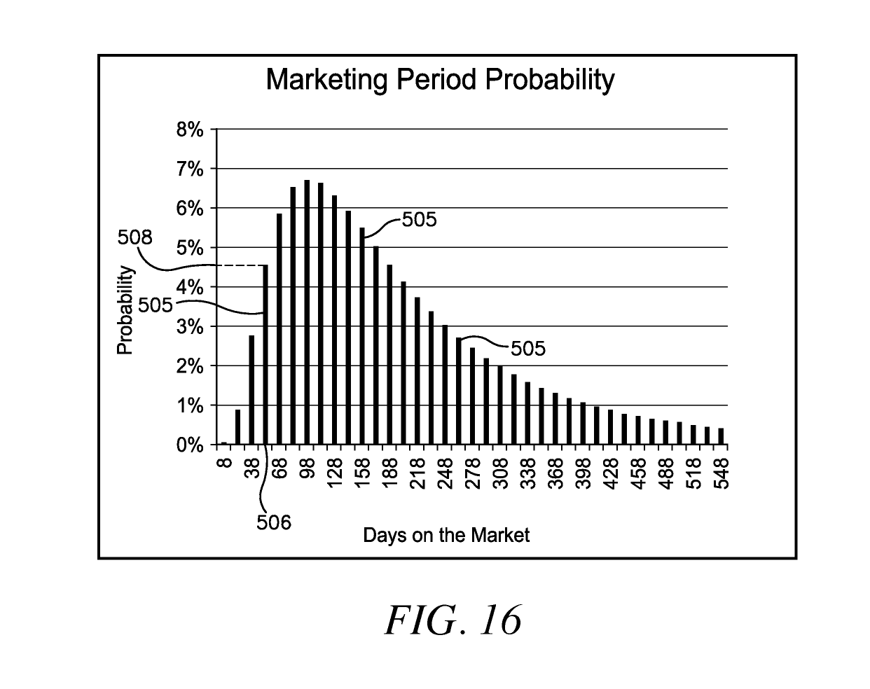

With reference to FIGS. 14-17, a method 400 for generating a probability-weighted DLOMᵥ and a double-probability-weighted DLOMₜᵥ for an asset based on probabilities associated with a range of price volatilities of representative assets is described in accordance with an embodiment of the invention. As indicated previously, subscript “v” is employed herein to differentiate values calculated with respect to the price volatility of the asset to be valued, subscript “t” is employed to designate values calculated with respect to marketing period or time, and subscript “tv” designates values calculated with respect to both volatility and marketing period.

Initially, a selection of one or more representative assets or properties is received as indicated at step 402. The representative assets or properties may also be referred to as guidelines or benchmarks and may comprise one or more publicly traded stocks, but can be any asset, property, commodity, or other item of value for which pricing data associated with the item over a period of time is available. The representative assets may be chosen based on one or more characteristics that are shared with the asset to be valued. For example, the representative asset and the asset to be valued may be in the same industry, sell similar products, be of similar size, or have similar business practices, among a variety of other characteristics. However, the representative asset and need not have any particular relationship with the asset to be valued.

For a publicly traded stock, the pricing data includes data like daily stock closing prices, split adjusted closing prices, or any other data useable to associate a value with the stock at a given time. For other forms of representative assets or properties the price data may include sales prices, listing prices, price volatility measurements or estimates, or any other data useable to associate a value with the representative asset at a given time.

As depicted at step 404, a selection of a time period for which to obtain the price data, i.e. a look-back period, may optionally be received, e.g. fifty days, one hundred days, two hundred fifty days, five hundred days, etc. In another embodiment, the time period may be preselected or set to a default time period. The selection of the time period may also include an indication of a valuation date from which to base the time period, or the valuation date might be set as the current date. The time period is typically measured back in time from the valuation date that is either the current date or a date prior to the current date. However, the price data can include future data that is projected or forecasted some time into the future using one or more price-data projection methodologies. As such, a DLOMᵥ and DLOMₜᵥ may reflect future price volatility expectations. Likewise, market data can include projected future data so that DLOMᵥ and DLOMₜᵥ would reflect future marketing period expectations.

The price data for each selected representative asset is obtained as indicated at step 406. The price data can be gathered from any available source. In one embodiment, the price data is downloaded electronically from one or more disparate data stores via one or more networks. For example, when the representative asset is a publicly traded stock, the price data may be downloaded from the respective stock exchange computing systems or from an intermediate system that obtains the data from the stock exchange. In one embodiment, electronic communication with the source of the price data is required to ensure that the most up-to-date price data is obtained.

When the valuation date is a future date, the price data for all or a part of the time period is calculated as depicted by step 408. Price data for any portion of the time period that stretches back from the future valuation date to a time equal to or before the current date can be obtained as described with respect to step 406.

At step 410, a plurality of price volatility values for the representative asset is obtained from the price data. The price volatility is a measure of the variation of the price from one temporal segment to the next—a higher volatility indicates a greater amount of variation. The price volatility values may be provided in the price data or price volatility can be calculated. To calculate the price volatility values, the time period is divided into a plurality of temporal segments as depicted at step 412a. For example, the time period might be divided into days, weeks, months, hours, etc. In some instances, the price data may be provided with respect to a plurality of temporal segments and thus can be divided differently or used as provided. For example, the price data may include a daily closing price of a stock and thus is already divided into temporal segments corresponding to one trading day but may be regrouped into temporal segments of multiple days, weeks, months, etc.

The volatility of the price data over each temporal segment is calculated at step 412b. In one embodiment, the volatility (σ) associated with a first temporal segment is calculated by dividing the price (P1) at the first temporal segment by the price (P2) at a second subsequent temporal segment; taking the natural logarithm of that quotient; and multiplying the absolute value of the quotient by the square-root of 250 (e.g. the number of market trading days in one year).

$$Volatility = σ = Abs ( ln ( \frac{P 1}{P 2} ) ) * \sqrt{250}$$

In another embodiment, the volatility is calculated by first determining the mean (m) of the prices for the representative asset depicted by the price data for each temporal segment (P1, P2, . . . PN). Next the difference (D) between of each of the prices from the mean is calculated. Each of the differences (D1, D2, . . . DN) is squared or raised to the power of two; the squared differences are summed; and the sum is divided by the total number of squared differences (N) to provide the average square of the deviations (S). The volatility (σ) is equal to the square root of the square of the deviations (S). It is understood that a variety of other methods for determining the volatility can be employed without departing from the scope of embodiments of the invention described herein.

$$Mean = m = \frac{P 1 + P 2 + … + PN}{N}$$

$$Deviation from mean D 1 = ( P 1 - m ) , D 2 = ( P 2 - m ) … DN = ( DN - m )$$

$$Average Square of Deviations = S = \frac{D {1}^{2} + D {2}^{2} + … + {DN}^{ 2}}{N}$$

$$Volatility = σ = \sqrt{S}$$

The meanᵥ and standard deviationᵥ of the calculated price volatilities for the temporal segments is next calculated as depicted at step 414. When more than one representative asset is selected, the price data for each representative asset is obtained and the meanᵥ and standard deviationᵥ for each is calculated separately. The meanᵥ and standard deviationᵥ for the one or more representative assets are averaged to provide a meanᵥ and standard deviationᵥ for the group of representative assets. The averaged value can reflect simple, harmonic, weighted, or another averaging methodology.

In another embodiment, the meanᵥ and standard deviationᵥ are provided by the user. The user may calculate the meanᵥ and standard deviationᵥ by another method or select a desired value for each. In an embodiment, the precision engine 310 discussed previously can be used to aid in the selection of representative assets.

At step 416 the meanᵥ and standard deviationᵥ, or the group meanᵥ and standard deviationᵥ when more than one representative asset is used, are provided to a statistical modeling engine or application. The statistical modeling engine is any one or more modeling engines that are useable to generate a statistical probability distributionᵥ indicating the probability that the asset to be valued will experience a given price volatility based on the meanᵥ and standard deviationᵥ provided thereto. For example, as described previously the statistical modeling engine may comprise one or more components of the Crystal Ball suite of modeling applications from the Oracle Corporation and may employ any available simulation or forecasting methodologies, such as Monte Carlo simulations and time-series forecasting. Other mathematical and statistical modeling tools or software such as R may alternatively be used or programmed to determine probability distributions. The statistical modeling engine transforms the meanᵥ and standard deviationᵥ into a probability distributionᵥ depicting the probability that the asset to be valued will have a given price volatility.

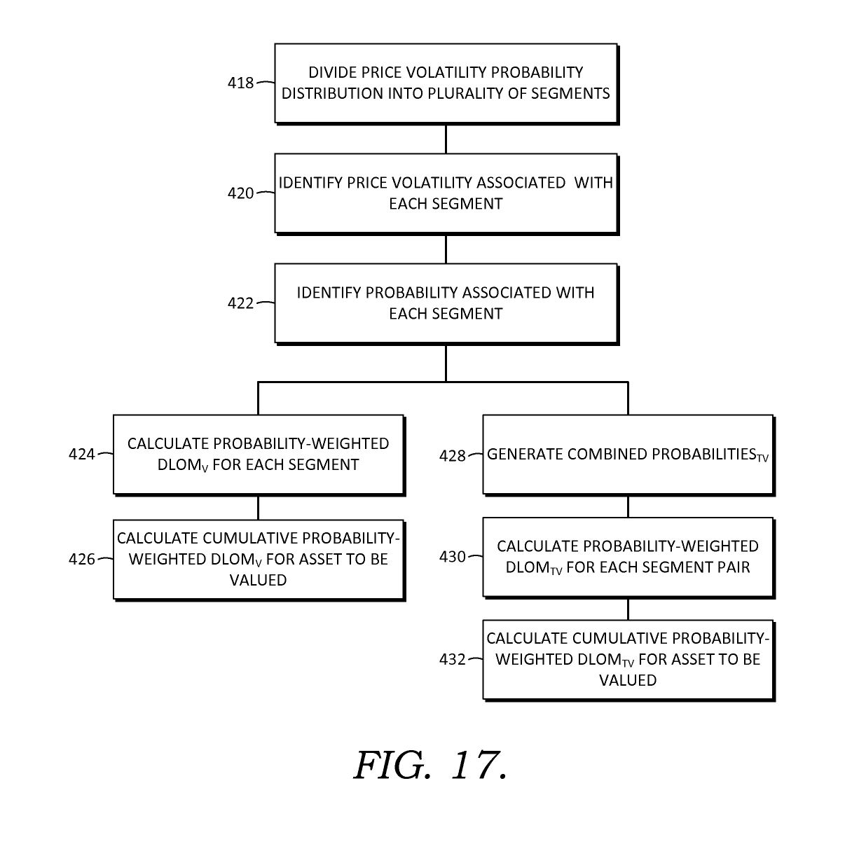

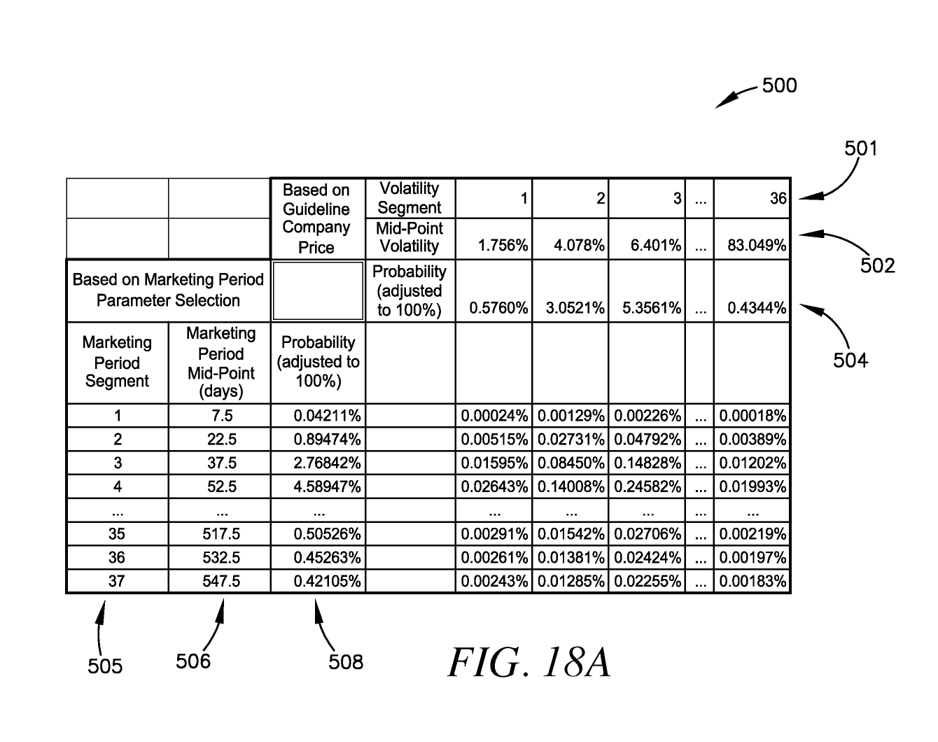

The probability distributionᵥ is preferably provided on a natural logarithmic scale (e.g. the logarithm with the base e, where e is approximately equal to 2.71828182845904 or Euler's number) but can employ a base ten logarithmic scale, or other logarithmic or non-logarithmic scale as desired. An exemplary probability distributionᵥ based on a natural logarithmic scale is depicted in FIG. 15. An exemplary probability distributionₜ based on marketing periods for the asset to be valued and generated as described previously above is also depicted in FIG. 16.

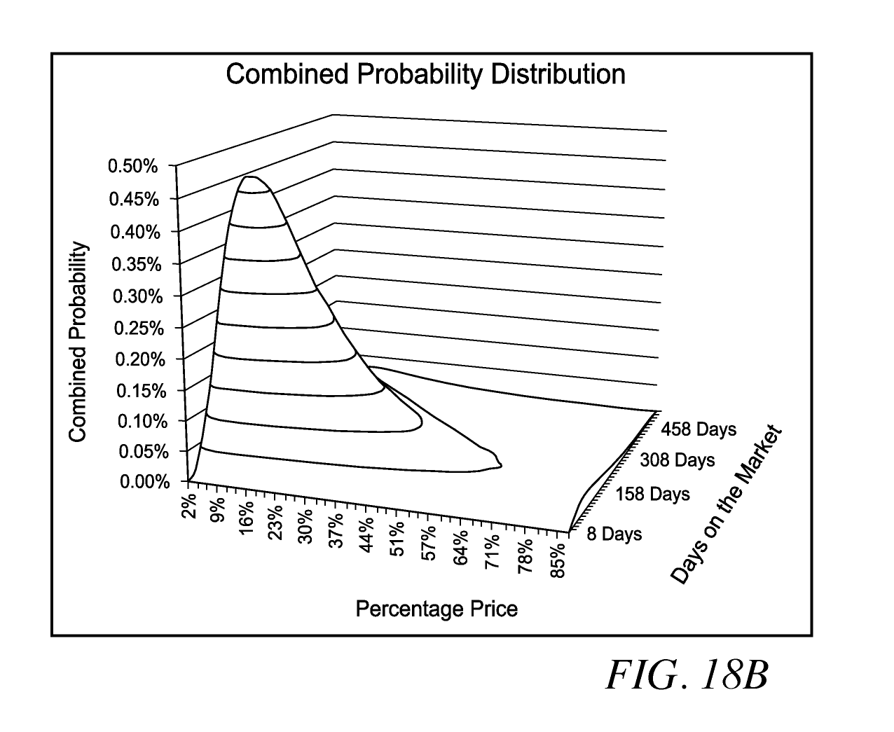

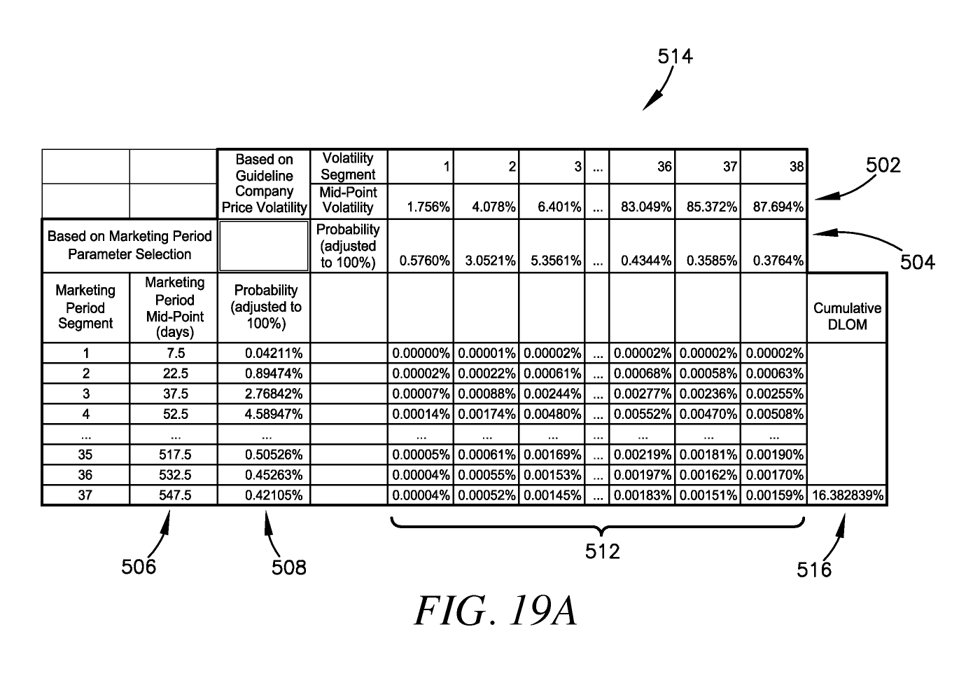

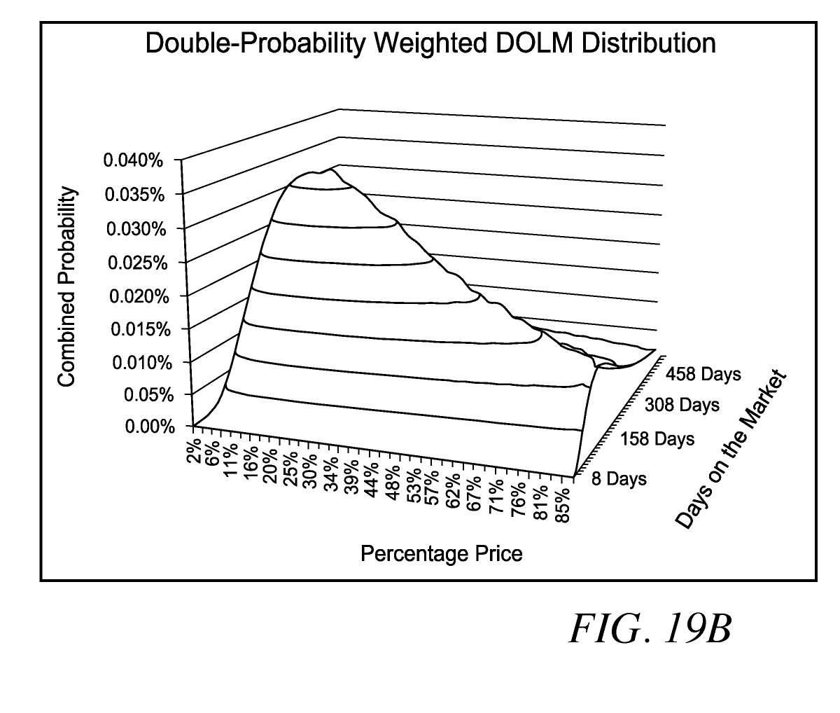

With additional reference to FIGS. 17 and 18A, the method 400 continues by breaking the volatility range of the probability distributionᵥ into a plurality of segments 501 as depicted at step 418. The volatility range can be broken into any number of segments 501 that are each of the same size or of variable sizes, e.g. each segment 501 represents an equal or unequal range of volatility values. A representative volatility value 502 is selected for each segment 501 at step 420. The representative volatility value 502 may be an initial value, end value, midpoint, or some other selected value within the respective segment 501. The probabilityᵥ 504 associated with each segment 501 as depicted by the probability distributionᵥ is identified at step 422.

The probability-weighted DLOMᵥ is calculated for each segment 501 using a formula, such as the Longstaff formula described previously, and using the respective volatility value 502 for the segment 501 and a predetermined marketing period value as inputs to the formula, as depicted at step 424. The resulting DLOMᵥ for each segment 501 is multiplied by the probabilityᵥ 504 associated with the segment 501 to weight the DLOMᵥ. The weighted DLOMᵥs for the plurality of segments 501 are then summed to form a cumulative probability-weighted DLOMᵥ for the asset to be valued based on price volatility probabilities.

Alternatively, a range of marketing periods can be employed in place of the predetermined marketing period value. As described previously with respect to the methods 100 and 200, a probability distributionₜ, such as the probability distributionₜ depicted in FIG. 16, can be generated based on marketing period data for selected representative assets. The probability distributionₜ is divided into a plurality of time periods 505, each with an associated marketing period value 506 and a probabilityᵥ 508 of occurrence.

As shown in FIG. 18A, an array 500 of the probabilities 504, 508 and values 502, 506 associated with the plurality of price volatility segments 501 and the plurality of time periods 505 may be generated. The array 500 aligns the values 502 of the price volatility segments 501 and their associated probabilitiesᵥ 504 along a first axis and the values 506 of the time periods 505 and their associated probabilitiesₜ 508 along a second axis. As shown in FIG. 18A and described above, the probabilities 504, 508 can be adjusted to account for the asymptotic behavior of the natural logarithmic curve of the respective probability distributions. For example, dividing the marketing period range and the price volatility range into 50 respective segments will result in 2,500 probability combinations.

At step 428, combined probabilities 510 are calculated for each combination by multiplying the probabilityᵥ 504 by the probabilityₜ 508 associated with the respective price volatility segment 501 and time period 505. A graphical representation of the combined probabilities may be generated as depicted in FIG. 18B. The graphical representation depicts the value of the combined probabilities 510 with respect to both the price volatility and the marketing period values 502, 506 collected from the respective probability distributions.

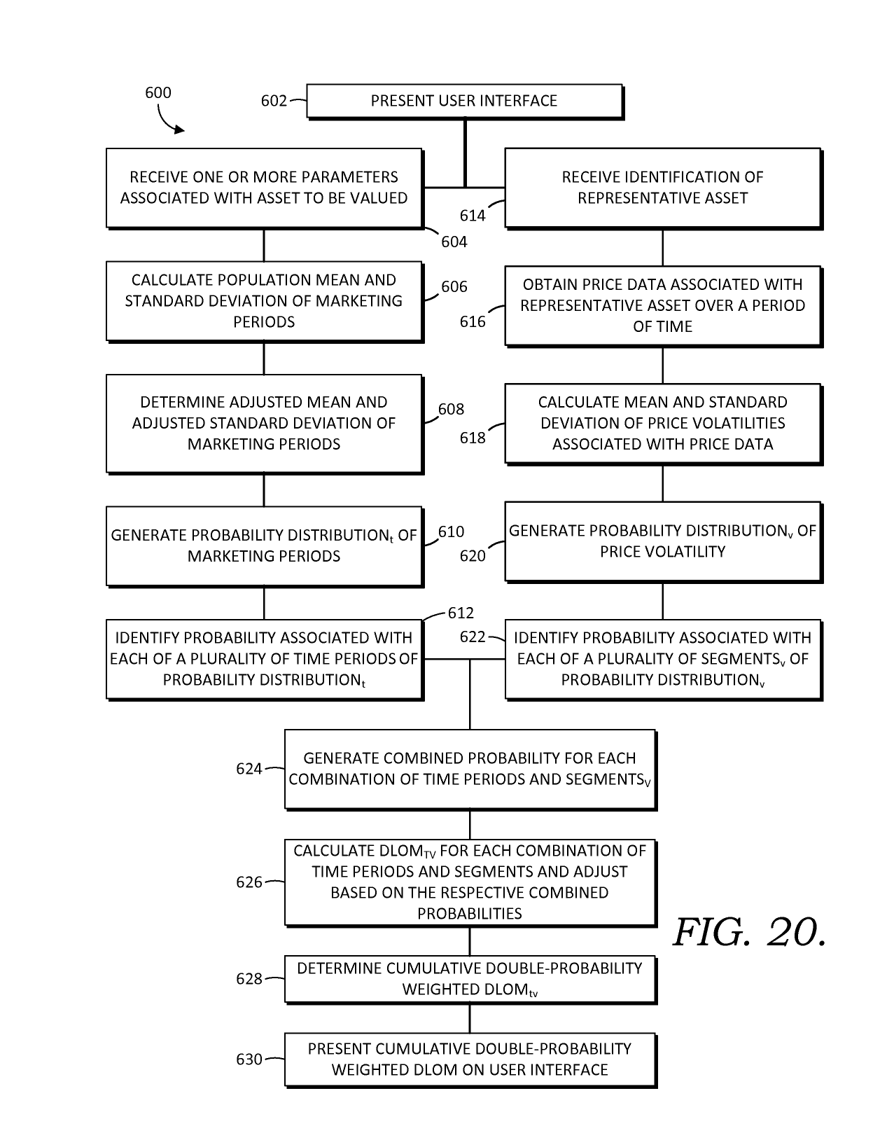

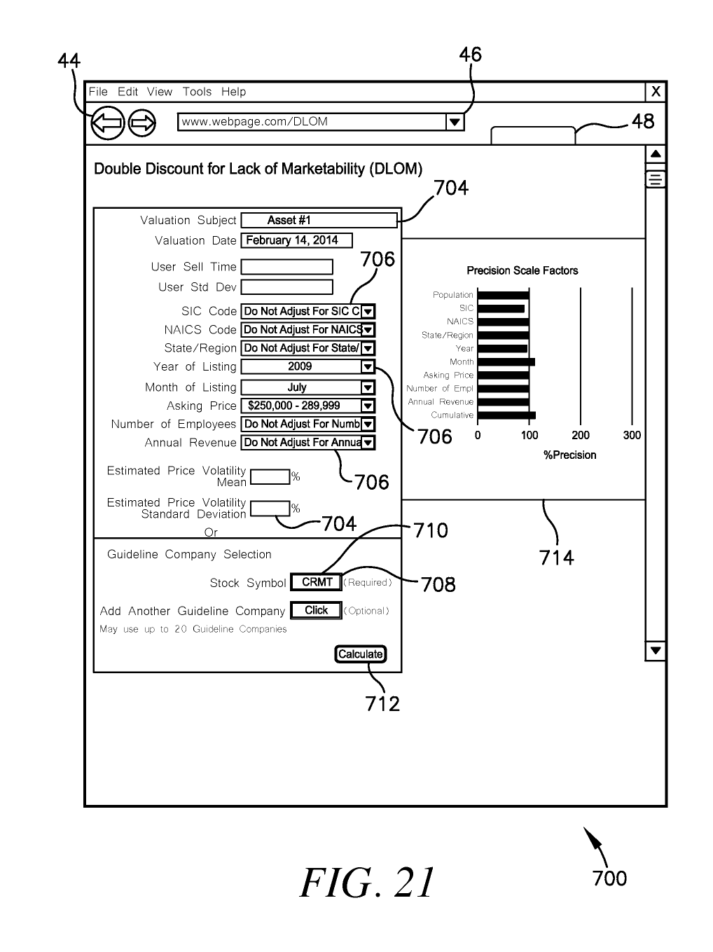

A DLOMₜᵥ is calculated for each combination of price volatility segment 501 and time period segment 505 as indicated at step 430. The DLOMₜᵥs are weighted by multiplying each DLOMₜᵥ by the respective combined probability 510 to provide a double-probability-weighted DLOMₜᵥ 512 for each combination as depicted in a second array 514 shown in FIG. 19A. The double-probability-weighted DLOMₜᵥs 512 for the combinations are then summed to generate a cumulative double-probability-weighted DLOMₜᵥ 516 for the asset to be valued as indicated at step 432. A graphical representation depicting the values of the double-probability-weighted DLOMₜᵥs 512 with respect to price volatility and marketing period may be generated as shown in FIG. 19B.

The cumulative double-probability-weighted DLOMₜᵥ thus represents the discount that should be applied to the value of the asset to be valued based on both the potential marketing period and the potential price volatility that might be encountered when trying to liquidate the asset. The graphical representation of the double-probability-weighted DLOMₜᵥs depicted in FIG. 19B and/or the data from which the graphical representation is generated further provides a powerful tool to a user for analyzing the effects of marketing period and price volatility on the valuation of the asset.

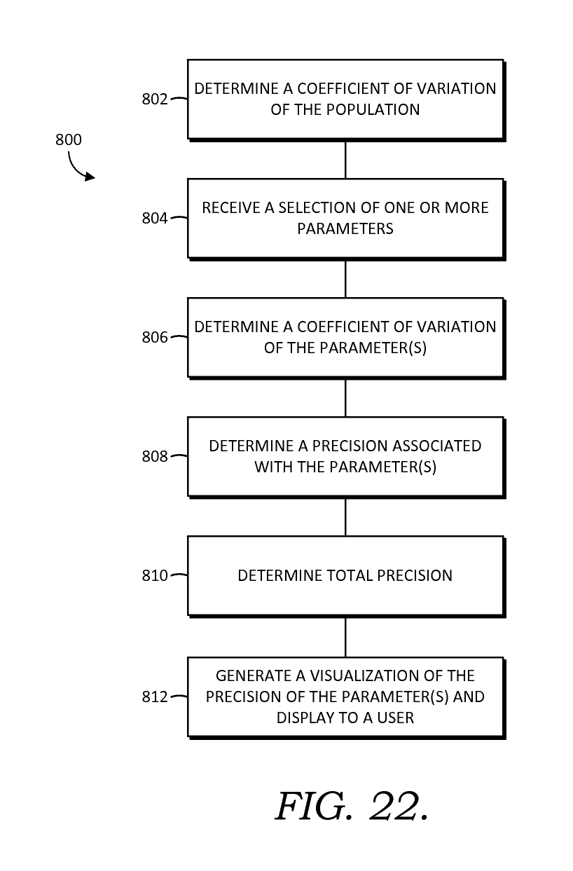

With reference now to FIG. 20, a method 600 for providing a cumulative double-probability-weighted DLOMₜᵥ for an asset to be valued based probabilities associated with both a range of price volatility and a range of marketing periods for the asset is described in accordance with an embodiment of the invention. The method 600 is carried out in a computing environment, such as the environment 10, and is conducted substantially in real time or at runtime. For example, the method 600 can be executed in a matter of a few seconds or minutes upon receipt of input data elements from a user. The method 600 is depicted as taking place along two separate paths for sake of clarity; one path including steps 604-612 for producing probabilitiesₜ based on a range of marketing periods for the asset, and a second path including steps 614-622 for producing probabilitiesᵥ based on a range of price volatility values for the asset. It is to be understood that the two paths can be executed simultaneously or serially and may be conducted all or in part in, or substantially in, real time.

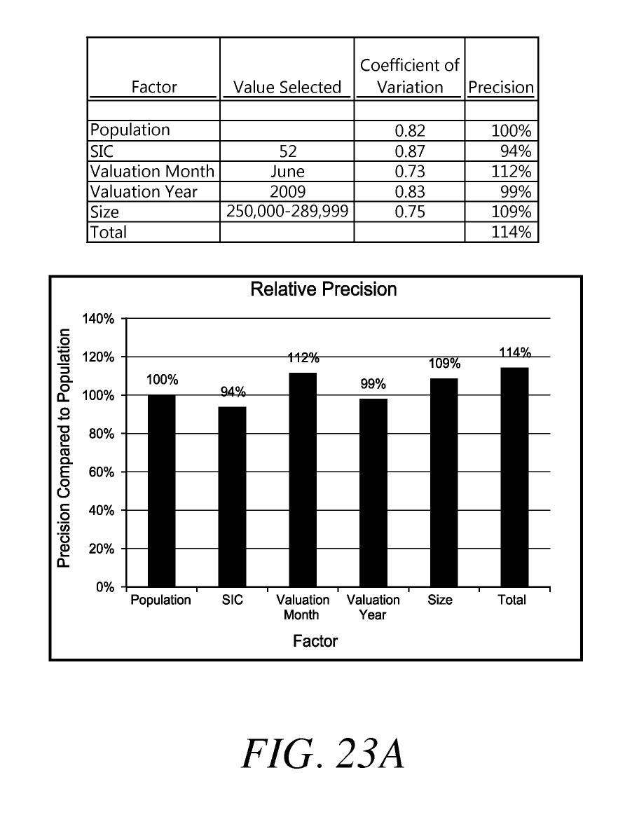

As indicated at step 602 a user interface is presented to a user. An exemplary user interface 700 is depicted in FIG. 21 and comprises a webpage communicated to the user's computing device via one or more networks and presented on a display device associated with the user's computing device. Although the user interface 700 is described herein as comprising a webpage, any form of user interface can be employed in embodiments of the invention. For example, the user interface might be generated by a program or application executing on the user's computing device and not received via a network.

In an embodiment, the method 600 is provided as a web-based or network-based service that employs network-based communications between disparate computing systems to collect up-to-date data elements, perform calculations at remote computing systems, and provide a streamlined, uniform, real time user experience. In such embodiments, network accessibility from the user's computing device is necessary to ensure that data for representative assets is current. Network accessibility may also ensure that adequate processing power and resources are available to users when performing a large number of calculations on substantial amounts of price and marketing period data for the representative assets, e.g. typical user's computing devices may not possess adequate processing power or memory. By employing networked resources, the quality of service associated with provision of the method 600 to users may be maintained.

In some embodiments, the user's computing device communicates inputs to a central computing system which carries out processing, collects data elements from other networked computing systems, and provides desired outputs to the user's computing device for presentation thereby. The central computing system may execute in an environment that is different from or not available on the user's computing device, such as the open-source software language R or GNU S, to provide certain, otherwise unavailable functionalities.

The user interface 700 includes a plurality of input fields 702. The input fields may include free entry fields 704 for receiving text, selection fields 706 configured to provide predetermined data elements, such as by drop-down menus or lists that are selectable, or structured text entry fields 708 that require inputs to be in a particular format, among a variety of other field types.

At step 604 one or more parameters associated with the asset to be valued are received. Upon receipt of the parameters or upon receipt of an indication to initiate calculations, such as via selection of an execute button 712, data associated with the parameters and with one or more representative assets are obtained from one or more disparate computing systems via one or more networks and at step 606 a population meanₜ and standard deviationₜ are determined based on data associated with previously completed sales of representative assets. An adjusted meanₜ and standard deviationₜ are calculated as indicated at step 608 and as previously described with respect to the methods 100 and 200. In one embodiment, the meanₜ and standard deviationₜ of one or more of the parameters may be input by the user.

The adjusted meanₜ and adjusted standard deviationₜ are transmitted to a statistical modeling engine executing on one or more disparate computing devices associated with a provider of the statistical modeling engine via one or more networks to generate a probability distributionₜ depicting the probabilityₜ that the asset will sell in a given marketing period. For example, the adjusted meanₜ and adjusted standard deviationₜ might be transmitted to computing systems operated by the Oracle Corporation and executing the Crystal Ball suite of modeling applications. Other mathematical and statistical modeling tools or software such as R may alternatively be used or programmed to determine probability distributions. The probability distribution is divided into a plurality of time periods. Probabilitiesₜ associated with each of the time periods are identified at step 612.

At step 614, which may correspond in time with the occurrence of step 604, a selection of one or more representative assets is received at the user interface. For example, a user may input or select one or more stock-ticker symbols for representative publicly traded businesses via a stock symbol input field 710 in the user interface 700. Upon receipt of the selection of representative assets or upon receipt of an indication to initiate calculations, such as via the execute or calculate button 712, price data associated with the representative assets for a given period of time is obtained from one or more disparate computing systems via one or more networks as indicated at step 616. For example, the user's computing device may communicate with a computing system at a stock exchange or at an intermediary that collects price data from the stock exchange and distributes it to the public.

A meanᵥ and standard deviationᵥ of the price volatilities calculated from the price data are determined as described above with respect to the method 400, as indicated at step 618. At step 620 the meanᵥ and standard deviationᵥ are transmitted to a statistical modeling engine and transformed into a probability distributionᵥ depicting the probability that the asset to be valued will sell with a given price volatility. For example, the meanᵥ and standard deviationᵥ might be transmitted to computing systems operated by the Oracle Corporation and executing the Crystal Ball suite of modeling applications. Other mathematical and statistical modeling tools or software such as R may alternatively be used or programmed to determine probability distributions. At step 622, the price volatility axis of the probability distributionᵥ is divided into a plurality of segments and a probabilityᵥ associated with each of the segments is identified.

At step 624 the possible combinations of the time periods and the volatility segments are identified and their respective probabilities combined. A DLOM is calculated for each of the possible combinations of the time periods and volatility segments using a formula, such as the Longstaff formula, with the time period and volatility values as inputs thereto. Each of the DLOMs is weighted by multiplying by the combined probability associated therewith to produce a double-probability-weighted DLOMₜᵥ as indicated at step 626. The double-probability-weighted DLOMₜᵥs are then summed to produce a cumulative double-probability-weighted DLOMₜᵥ at step 628.

The cumulative double-probability-weighted DLOMₜᵥ and any desired additional data is presented to the user via the user interface as indicated at step 630. In an embodiment, DLOMs calculated via one or more alternative methods or formulas are presented. Informational or reference materials or links thereto or the like might also be provided.

In one embodiment, a display 714 associated with a precision engine, such as the precision engine 310, is included in the user interface 700 or is provided via a separate interface. As described previously, the precision engine provides an indication of the effect selection of one or more parameters has on the precision of the data associated with the population of previously sold assets employed to generate the probability distributionₜ. The precision engine can also be applied to price volatility obtained for each of the one or more representative assets, for example the stock prices of publicly traded companies, to provide an indication of the effect selection of one or more of the representative assets has on the probability distributionᵥ. The display 714 may be configured as a bar graph depicting a precision of the data associated with the population as a whole, the precision of data associated with each particular selected parameter relative to the precision of the population, and a cumulative precision resulting from selection of the parameters. It is understood that there may be a variety of ways to provide or organize the display 714, all of which are understood as falling within the scope of embodiments of the invention described herein. The display 714 may be generated in real time to enable a user to tailor the selection of particular parameters to achieve a desired precision level before causing the execution of the method 600 for calculation of DLOM values based on the selected parameters.

In another embodiment, an estimation of a marketing period and/or of a price volatility is provided. To provide the estimation, the method 600 is carried out as described above to generate a probability distributionₜ of marketing periods, as depicted at step 610, and/or to generate a probability distributionᵥ of price volatility, as depicted at step 620. As described previously, a mean and standard deviation associated with a population, marketing periods, price volatilities, parameters, or other data elements may be received rather than calculated and the probability distributions generated based thereon. Steps 612, 622, and 624 might also be carried out to generate a combined probability for the combination of marketing period and price volatility. The probability distributionₜ, such as that shown in FIG. 16, the probability distributionᵥ, such as shown in FIG. 15, and/or the combined probability distributionₜ, such as shown in FIG. 18B, may be generated and presented to the user.

Accordingly, the user can be provided with a way of estimating and assessing time periods or marketing periods associated with an asset to be sold. For example, the user might employ a probability distributionₜ to assess how long an asset will be on the market before being sold or to assess the likelihood that an asset will sell after a given date, among other assessments. The user can also be provided with a way of estimating or assessing price risks associated with an asset, e.g. based on the probability distributionᵥ, the user can identify a probability that a current price of an asset will change over time.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to demarcate those structures as including a plurality of possible arrangements or designs within the scope of this disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

What is claimed is:

1. A computer-implemented method for generating a discount for lack of marketability (DLOM) for an asset to be valued, the method comprising:
receiving, by a computing device, a mean and a standard deviation useable to represent price data for the asset, the computing device having a processor and a memory and comprising one computing device or a plurality of computing devices communicatively coupled via one or more networks;
transforming the mean and a standard deviation into a probability distribution representing a probability that the asset will have a particular price volatility value; and
determining a DLOM for the asset using a formula and a price volatility value represented in the probability distribution.

2. The computer-implemented method of claim 1, further comprising:
weighting the DLOM using the probability associated with the price volatility value as represented by the probability distribution to generate a probability-weighted DLOM.

3. The computer-implemented method of claim 1, wherein the method is carried out substantially in real time.

4. The computer-implemented method of claim 1, wherein the mean and standard deviation derive from transaction price data for at least one representative asset.

5. The computer-implemented method of claim 4, wherein the computing device is communicatively coupled via the one or more networks to a memory storing a plurality of data elements associated with the at least one representative asset.

6. The computer-implemented method of claim 4, further comprising:
receiving a selection of the at least one representative asset for which to collect the price data, the price data including a price of the at least one representative asset on each of a plurality of temporal points.

7. The computer-implemented method of claim 6, further comprising:
projecting one or more future price data elements representing predicted prices of the at least one representative asset on one or more temporal points in the future.

8. The computer-implemented method of claim 4, further comprising:
determining a plurality of price volatility values for the at least one representative asset based on the price data, each of the price volatility values in the plurality being calculated for prices of the at least one representative asset within a period of time; and
determining the mean and standard deviation of the plurality of price volatility values for the at least one representative asset.

9. The computer-implemented method of claim 1, further comprising:
dividing a range of price volatility of the probability distribution into a plurality of segments, each segment having a representative price volatility that is in the segment, and each representative price volatility having an associated probability defined by the probability distribution; and
using the formula to determine a segment-specific DLOM of the asset for each segment based at least on the representative price volatility for each selected segment.

10. The computer-implemented method of claim 9, further comprising:
calculating the probability-weighted DLOM for the asset by multiplying the segment-specific DLOM for each segment by the probability associated with each representative price volatility and summing the products.

11. The computer-implemented method of claim 10, further comprising:
generating a combined probability for each of the segments by multiplying the probability associated with the representative price volatility by a second probability associated with a marketing period;
using the formula to determine a segment/marketing-period-specific DLOM of the asset for each segment/marketing-period combination based at least on the representative price volatility for each selected segment and the marketing period.

12. The computer-implemented method of claim 11, further comprising:
calculating a cumulative double-probability-weighted DLOM for the asset by multiplying the segment/marketing-period-specific DLOM for each segment by the combined probability associated with each segment/marketing-period combination and summing the products.

13. One or more non-transitory computer-readable media having computer-executable instructions embodied thereon that, when executed by a computing device having a processor, perform a method for generating a discount for lack of marketability (DLOM) for an asset, the method comprising:
presenting a user interface on a display device of a computing device having a processor, the computing device comprising one or more computing devices;
receiving via one or more fields in the user interface a selection of a representative asset, price data for which is useable to represent price data for the asset;
generating a statistical probability distribution based at least partially on the price data for the representative asset, the probability distribution representing a probability that the asset will have a particular price volatility value; and
determining a probability-weighted DLOM based on a formula that employs the price volatility values from the probability distribution as inputs thereto.

14. The computer-readable media of claim 13, wherein determining the probability-weighted DLOM based on the formula that employs the price volatility value and the probability from the probability distribution as inputs thereto further comprises:
determining a segment-specific DLOM of the asset for each of a plurality of segments of a range of price volatilities depicted by the probability distribution, a representative price volatility value associated with each of the selected segments being input to the formula.

15. The computer-readable media of claim 14, further comprising:
weighting each of the segment-specific DLOMs using the probability of the asset having the representative price volatility value defined by the probability distribution.

16. The computer-readable media of claim 15, further comprising:
producing the probability-weighted DLOM by summing the weighted segment-specific DLOMs.

17. The computer-readable media of claim 13, wherein execution of the computer-executable instructions embodied thereon by the computing device performs the method for generating the probability-weighted DLOM for the asset substantially in real time.

18. The computer-readable media of claim 13, wherein the method further comprises:
generating a second probability distribution depicting a plurality of marketing periods and a respective second probability associated with each of the marketing periods in the plurality, the second probability indicating the probability that the asset will sell in the respective marketing period;
identifying combinations of the plurality of marketing periods with the price volatility value; and
generating a combined probability for each of the combinations, the combined probability being equal to the product of the probability and the second probability.

19. The computer-readable media of claim 18, wherein the method further comprises:
determining a marketing-period specific DLOM for each of the marketing periods using the marketing period and the price volatility value as inputs to the formula; and
weighting each of the marketing-period specific DLOMs by multiplying the marketing-period specific DLOM by the respective combined probability to produce a weighted marketing-period specific DLOM.

20. The computer-readable media of claim 19, wherein the method further comprises:
summing the weighted marketing-period specific DLOMs to produce a double-probability-weighted DLOM for the asset.

21. The computer-readable media of claim 18, wherein the method further comprises:
receiving a selection of one or more parameters associated with at least a portion of a population of asset sales transactions, the second probability distribution being generated based on data associated with at least a portion of the asset sales transactions in the population;
determining a coefficient of variation of marketing periods associated with the asset sales transactions for the population and for the asset sales transactions associated with each of the one or more parameters; and
determining a precision of the coefficient of variation of marketing periods for each of the one or more parameters with respect to the population.

22. The computer-readable media of claim 21, wherein the method further comprises:
generating a graphical representation of the precision of each of the one or more parameters and the population on the user interface.

23. A computer-implemented system for generating a probability adjusted discount for lack of marketability (DLOM) for an asset, the system comprising:
a web-based user interface provided by a computing device having a processor, the user interface having a plurality of fields configured to receive an identification of price data which is useable as representative price data for the asset, and the computing device comprising one or more computing devices communicatively coupled by one or more networks;
a database disposed on one or more non-transitory computer readable media and accessible by the computing device, the database containing at least a portion of the price data;
a statistical modeling engine operable by the computing device to transform a mean and a standard deviation of a plurality of first price volatility values depicted in the price data into a probability distribution defining probabilities of the asset having each of a plurality of second price volatility values; and
a calculation-component configured to determine a probability-weighted DLOM for the asset based at least partially on the second price volatility values and the probabilities of the asset having the second price volatility values depicted by the probability distribution.

24. The system of claim 23, wherein the statistical modeling engine is operable to generate a visualization on the user interface of the probability distribution.

25. The system of claim 23, wherein the calculation-component determines the probability-weighted DLOM for the asset by applying an option pricing formula to one or more of the second price volatility values depicted in the probability distribution to generate a plurality of volatility-specific DLOMs, multiplying the plurality of volatility-specific DLOMs by the probability associated with each respective price volatility value depicted by the probability distribution, and summing the products.

26. The system of claim 23, further comprising:
a precision engine operable to generate a graphical representation of the precision of marketing period data associated with a selection of asset sale transactions, the precision engine receiving a selection of one or more parameters associated with at least a portion of a population of asset sales transactions, determining a precision of the marketing period data associated with each of the one or more parameters with respect to the population based on respective coefficients of variation, and generating the graphical representation on the user interface.

27. One or more non-transitory computer-readable media having computer-executable instructions embodied thereon that, when executed by a computing device having a processor, perform a method for generating a discount for lack of marketability (DLOM) for a asset, the method comprising:
receiving a user interface presented on a display device of a computing device having a processor, at least a portion of the user interface or data presented therein being communicated to the computing device via a network;
receiving via one or more fields in the user interface a selection of at least one representative asset, price data for which is useable to represent price data for the asset;
triggering the computing device to generate a statistical probability distribution representing a probability that the asset will have one of a plurality of price volatility values;
generating the probability-weighted DLOM based on an option pricing formula that employs one or more of the plurality of price volatility values from the probability distribution as inputs to the formula to produce a DLOM, the DLOM being weighted based on the respective probability defined by the probability distribution for each of the one or more price volatility values to produce the probability-weighted DLOM; and
receiving via the display device the probability-weighted DLOM.

28. The computer-readable media of claim 27, wherein the method further comprises:
generating a cumulative double-probability-weighted DLOM based on the formula, the one or more price volatility values and one or more marketing period values being paired in a plurality of combinations and each combination input to the formula to produce a second DLOM, the second DLOM being weighted by combined probabilities comprising the probability associated with the respective price volatility and a probability associated with the marketing period of the respective pair to produce a double-probability-weighted DLOM, and the double-probability-weighted DLOMs being summed to produce the cumulative double-probability-weighted DLOM; and
receiving via the display device the cumulative double-probability-weighted DLOM.

29. A computer-implemented method for measuring a precision of a subset selected from a population, the method comprising:
receiving a selection of a parameter, the parameter defining a subset of a population of data elements;
determining a first coefficient of variation of values of data elements in the population;
determining a second coefficient of variation of values of data elements in the subset; and
determining a precision associated with the data elements in the subset with respect to the data elements in the population based on a ratio of the first coefficient of variation for the population and the second coefficient of variation of the subset.

30. The computer-implemented method of claim 29, further comprising:
generating a graphical representation of the precision of the data elements in the subset with respect to the population on a user interface.
